(19) United States
(12) Patent Application Publication
(10) Pub. No.: US 2002/0052900 A1
(43) Pub. Date: May 2, 2002

(54) Computer assisted text input system

(76) Inventor: Alfred Boyd Freeman, Hooksett, NH (US)

Correspondence Address: ALFRED BOYD FREEMAN, UNIT 377, 1465 HOOKSETT ROAD, HOOKSETT, NH, 03106, US

(21) Appl. No.: 09/859,875

(22) Filed: May 17, 2001

Related U.S. Application Data
(60) Provisional application No. 60/204,102, filed on May 15, 2000.
(60) Provisional application No. 60/204,201, filed on May 15, 2000.

(51) Int. Cl. G06F 17/00

(52) U.S. Cl. 707/531

(57) ABSTRACT

The disclosure includes five different display presentations, two for Handheld computers and three for Laptops or Desktops, for the word start inputs with a Stylus, Mouse or other type Pointer. Pointer selects displayed items and executes strokes to input text to computers. Displayed items include starting letters, or SLs, very frequent words, or VFWs, Digits, and 2^{nd}, 3^{rd}, and 4^{th} letters of SLSs. Strokes and ‘Sections’ diagrams and tables show assignments obtained. Six SL and SLS obtained word set presentations enable further word inputs with a Pointer. Pointer strokes from Digits input members shown in table. Strokes following VFW and other word selections obtain ‘Associated Inputs’ of tables as specified by Codes with words. Strokes following SL and SLS inputs add letters to extend SLSs for smaller word sets from vocabulary holding strings of the word stems of an abridged dictionary. Special ‘Letter Groups’ effectively extend SLSs with eight strokes.

A 1^{st} Handheld model has SL and VFW displayed items. SL inputs single letter to access word sets from a Vocabulary. VFWs input VFWs. Strokes with SLs obtain various letter inputs and change vocabularies. Strokes with VFWs obtain ‘Associated Inputs’, which include inflected forms, in place of VFWs. A 1^{st} Laptop and Desktop model functions like the Handheld model with larger word sets. A 2^{nd} Laptop and Desktop model assigns both a VFW and an SLS to each displayed item. Mouse buttons select VFWs or SLSs. Universal model for Handheld, Laptop and Desktop employs Vocabulary with strings of the word stems of an abridged dictionary and has displayed items consisting of Digits, SL and 2^{nd},3^{rd} and 4^{th} letters of SLSs. SL and letter displayed items have both VFW and SLS assignments, the VFW being most frequent words with the respective SLS. Word sets obtained display on Desktop but not Handheld computers. Strokes extend SLSs for word sets displayable on Handheld computers.

A Japanese language model employs both starting syllables and number of strokes of Ideographic characters to access word sets. Words coded as nouns or pronouns, verbs, and adjectives or adverbs enable strokes to add appropriate post positions or inflections. A Chinese language model employ Radicals and number of strokes to access word sets via a Radical Index.

This application is a continuation-in-part of my Provisional Patent Application No. 60/204,102 filed May 15, 2000 for a “Word-Based Text Input System Using Touch Screen” and my Provisional Patent Application No. ______ filed Mar. 6, 2001 for a “Computer Assisted Text Input System”. The parent disclosures are included herein by reference.

### BACKGROUND OF THE INVENTION

1. Field of the Invention

This invention is directed to improvements in text input systems for computers and the like and particularly to systems using displays and pointing devices to input words and other text data.

2. Discussion of the Prior Art

Applicant's U.S. Pat. No. 5,621,641 for a Computer Assisted Text System and U.S. Pat. No. 5,649,223 for a Word Based Text Producing System employ strokes with a handheld device to input letters and other characters. U.S. Pat. No. 5,621,641 uses a mouse as the handheld device and U.S. Pat. No. 5,649,223 uses a pen on a digitizing pad. The strokes consist of minimal movements in patterns that are simpler than handwritten letters or Graffiti strokes. The strokes are distinguished by direction and by straight, curved clockwise and curved counterclockwise trajectories. Where more strokes are needed, length and/or speed serve as distinguishing parameters. One model uses eight directions that are easily distinguishable by most users. Eight directions each yield eight straight strokes, eight curved clockwise strokes, and eight curved counterclockwise strokes for a total of 24.

The afore referenced U.S. Pat. Nos. 5,621,641 and 5,649,223 set forth systems for producing text with fewer input actions. The systems start each word with a display of the most frequent word (MFW) set which comprises over 30% of the words of typical text documents. If the word a user wants is one of these MFWs, he can obtain it with a single key or stroke action. Else the user inputs successive starting letters of the wanted word with the keys or strokes of a handheld device. Each successive letter accesses a word set from the system's vocabulary which may include the wanted word. The word sets are ordered by frequency of use so the more frequent words show up from the fewer starting letters.

Most of the words in the system vocabulary are word stems which combine with suffixes to form many more words. The user selects the word stem and then the suffix to produce these words. The patent system automatically handles the sometimes complex spelling changes necessary to properly apply suffixes to word stems by employing a set of Spelling Rules and a large number of modification arrays. [A modification array for each suffix holds a set of word endings and the spelling changes to the endings and the suffix with application of the suffix.] In addition, the system codes the stems of irregular forms and other exceptions for the required spelling changes. By way of example for extensive spelling changes: “ion” changes “acquire” to “acquisition”; and “assume” to “assumption”.

In addition to less physical action, word writing requires less spelling recall than letter by letter writing. The recall and the action for each letter, for handwriting or Graffiti strokes or ‘Hunt & Peck’ typing, requires mental, as well as physical, effort. An exception may be skilled typists who have typed so much that thought of a word triggers the sequence of finger actions that produce the word. The spelling is apparently stored in subconscious memory as many typists, when asked to spell words typed for years. turn to the keyboard. Having enough word action sequences embedded in the subconscious may be the key to fast typing.

U.S. Pat. No. 5,784,060 to Randal Lee Bertram and Frederick Champion for a Mobile Client Computer Programmed to Display Lists and Hexagonal Keyboard is assigned to International Business Machines Corp. The application for this patent was one of a series of related applications for “Mobile Client Computers”. This patent discloses a virtual, or ‘soft’, keyboard with hexagonal-shaped keys, claimed to make better use of the available area. The keyboard can be morphed into different shapes to adapt for particular sets of inputs and accompanying data lists.

U.S. Pat. No. 6,002,390 to Toshiyuki Masui for a Text Input Device and Method has a liquid crystal panel and a pressure sensitive tablet functioning as a virtual keyboard with keys for Japanese syllables and for other controls for a pen input. Pen to key inputs results in computer apparatus accessing sets of words and phrases for display on liquid crystal panel. Users can select words and phrases with a pen for text input. Masui does not start words with a display of words for selection but requires virtual key inputs to obtain displays of word sets for input.

U.S. Pat. No. 5,832,113 to Teruo Sano has a display presenting a virtual keyboard with a single character on each key. A pen inputs different characters from the keys depending on the manner in which the pen touches the key. A simple touch, for example, obtains lower case letters while a pen motion making a checkmark obtains upper case letters.

The widely used Microsoft Windows operating system positions a cursor on the computer screen is response to movements of a Mouse. Windows sends messages on mouse button operations and on cursor screen positions. Mouse operations select menu items, choose items, on the Internet, etc. Applicant does not know of any applications involving comprehensive text input.

The very popular products of Palm Computer use a Stylus with a Touch Screen and a Touch Detector. The system has the capabilities to satisfy the instant invention requirements for a pointing means.

### SUMMARY OF THE INVENTION

The objective of the instant invention is a better way to input alphabetic languages to computer type apparatus without a keyboard by employing a display and a pointing means.

A further objective of the instant invention is a text input system of the foregoing type with the capability to input roughly half of the words of average text with single actions.

A yet further objective of the instant invention is a text input system of the foregoing type that obtains nearly all remaining words of an abridged dictionary with two input actions.

A further still objective of the instant invention is a text input system of the foregoing type that inputs inflected forms of word stems and pairs of words with single actions.

A still further objective of the instant invention are text input systems of the foregoing type that work similarly on computers ranging from handheld to desktop.

Another objective of the instant invention is a text input system of the foregoing type which has somewhat less text inputting capability but is easier to learn and use.

Other objectives and advantages of the instant invention will become apparent from the following description.

The instant invention text input system for Handheld, Laptop, Desktop and other computers employs any pointing means from Stylus to Mouse to input text by selecting displayed items and executing strokes. On word starts, a first, or simplest, Handheld computer model presents sets of Digits, starting letters, or SLs, and very frequent words, or VFWs. A tap with a Stylus, or other pointing means, on a Digit inputs the word for the digit, “one” for ‘1’, “two” for ‘2’, etc. A tap on an SL obtains a display of a set of words with the SL. A tap on a displayed word stem inputs the word stem. A tap on a VFW, inputs the VFW. A short Stylus movement, or stroke, in one of eight directions after touch down on a VFW or a word stem substitutes an ‘Associated Input’. The ‘Associated inputs’ are generally inflected forms but also include related words and accompanying words. Strokes after touch down on a Digit obtain words and characters related to the Digit. An SL and a set of eight strokes affect capitalization, switch vocabularies, letter inputs, etc.

First Laptop and Desktop models function substantially the same as the just described Handheld model except that it is likely a Mouse or other cursor positioning pointing means, such as a track ball, finger sensing, or pressure responsive device, replaces the Stylus. With larger displays, these models have larger word sets and may also have more VFWs and/or SLSs. For second Laptop and Desktop models, a vocabulary storing strings of the word stems of an abridged dictionary replaces the word set vocabulary and double VFW and SL assignments. Two or more starting letters of VFWs become starting letter string, or SLS, assignments and SLs receive both VFW and two letter SLS assignments. Strokes from SLs produce still more SLS inputs. Mouse buttons select the VFW or SLS assignment for input from selection of each displayed item. The available SLS inputs obtain all of the abridged dictionary words in displayable word sets. Single input actions input roughly half of text document words and two actions input nearly all of the rest of the words.

A second Handheld computer model matches the second Laptop and Desktop models in obtaining nearly all of the words of an abridged dictionary with two actions. This model replaces the Handheld model VFW displayed items with the 2^{nd}, 3^{rd}, and 4^{th} letters of SLSs and adopts the double assignments of the second Laptop and Desktop models. The VFWs are the most frequent words with the SLSs from the displayed items The SLS from a 2^{nd} letter in an SL area, for example, is the SL plus the 2^{nd} letter. Taps with Stylus on the SLs and on 2^{nd}, 3^{rd}, and 4^{th} letters input VFWs. Stylus touch downs followed by strokes obtain SLSs instead of VFWs. The strokes not only select SLSs by add letters to extend the SLSs. As fewer word stems match longer SLSs, the longer SLSs obtain smaller word sets that are displayable on Handheld computers. The instant invention devised a special set of eight ‘Letter Groups’ to save on the number of strokes necessary to extend SLSs. Eight strokes with ‘Letter Group’ assignments make the SLS extensions. This model has to use a different type stroke to obtain ‘Associated Inputs’.

Laptop and Desktop versions of the second Handheld model take advantage of the larger displays by adding a few 2^{nd}, 3^{rd}, and 4^{th} letters and retaining a few VFWs. One Mouse button obtains VFWs and another SLSs and so eliminates the need for different type strokes for ‘Associated Inputs’. Strokes with the Mouse or other pointing means extend SLSs to obtain smaller word sets when needed for Laptops or just to obtain easier to search sets. The sets are not only smaller but have Markers dividing the words into smaller groups. Single letters obtain word sets with 2^{nd} letter Markers, two letter SLS sets have 3^{rd} letter Markers, and three letter SLS sets have 4^{th} letter Markers. Searches start with location of the Marker for the 2^{nd}, 3^{rd} or 4^{th} letters of the word wanted. Handheld, Laptop, and Desktop models can all use the same vocabulary of strings an abridged dictionary word stems instead of different ones with word sets sized for the different displays.

An alternative model for Desktops changes all displayed items to VFWs with their SLSs being the SLS inputs. This model shows all of the VFWs and the SLSs as their starting letters, perhaps ideal for beginners. More displayed information for visual scanning and a larger area to cover on word starts may limit the speed attainable with experience.

All word start presentations have the capitalized SLs marking the areas for all inputs for words starting with the respective letters. Users go to the area for the starting letter of all wanted words, whether for a VFW or another word set or even to input a letter. The Digits, with the important number words, occupy a convenient corner on all models.

Models with VFWs as displayed items have an alternative to strokes for inputting ‘Associated Inputs’ for the VFWs and all models have the option for other word stems. The option is to select ‘Sections’ of displayed words with the pointing means. ‘Sections’ consist of the upper and lower halves of the letters and following ‘Spaces’ of displayed words. With the same assignments, strokes override ‘Sections’ to correct for misses on ‘Sections’.

Miscellaneous features include obtaining “a” and “an” from a single input. The program adds ‘n’ after ‘a’ when the next words starts with a vowel or vowellike sound. Pop up displays show ‘Associated Inputs’ to beginners in response to pointer pauses on VFWs and other words. ‘Hops’, an alternate type of stroke for a Stylus, inputs punctuation and other word endings.

‘Associated Inputs’ are specified by word stem codes to cover inflected forms, related words, and 2^{nd} words. Many words are inflected forms. The large number of frequent words starting with ‘th’ and ‘wh’ are handled as related words. 2^{nd} words are words than frequently accompany the stem and enable inputting pairs of words, such as “of the”, “in a”, etc., with one action.

The Japanese language model uses a combination of starting syllables and number of Ideographic character strokes to access word sets from a vocabulary of words. The Pointer selects the syllables from the word start display and executes strokes to obtain the the numbers of Ideographic strokes. VFWs and word set word stems have codes to indicate part of speech: noun or pronoun, adjective or adverb, or verb. The code of selected VFWs and word stems enables Pointer strokes to make appropriate additions: post positions for nouns or pronouns; inflections for adjectives or adverbs; and inflections for verbs. Pointer strokes further expand roots into demonstration words and add Classifiers to Digit inputs of numbers.

The Chinese language model displays Ideographic Radicals on word starts. The Pointer selectively obtains either VFWs or the Radical identity number to access the next word set from a vocabulary. The VFWs are the most frequent words starting with an Ideographic character having the respective Radical. Pointer strokes input the number of strokes combined with the Radical to complete the Ideographic character. The Radical number and the number of remaining Ideographic strokes access the Radical Index of the vocabulary for indexes to lists of words which may contain the wanted word.

### DESCRIPTION OF THE DRAWINGS

FIG. 1 is a functional block diagram of the text input system for a host computers having a display and a pointing means, such as a Mouse or a Stylus and a Touch Screen.

FIGS. 2a and 2b are a plan views of word start displays of Digit, staring letter, or SL, and VFW displayed items on Handheld and Desktop computers respectively.

FIGS. 3a and 3b are plan views of word start displays of Digit, SL, VFW, 2^{nd} letter, and some 3^{rd} and 4^{th} letter displayed items on Handheld and Desktop computers respectively.

FIG. 3c is a plan view of a word start display of Digit, SL, and VFW displayed items on a Desktop computer using VFWs for both word and SLS inputs.

FIG. 4 is a plan view of relative directions of eight straight strokes and ‘Hops’.

FIGS. 5a, 5b, and 5c are plan view of the respective displays of VFWs “do”, “if”, and “have” and their following ‘Spaces’ divided into ‘Sections’.

FIG. 6 is a table of assignments for different stokes from different displayed items.

FIG. 7a is a table of VFWs with irregular inflections as ‘Associated Inputs’.

FIG. 7b is a table of words starting with ‘th’ and ‘wh’ in related word sets.

FIG. 7c is a table of number values and words associated with displayed digits.

FIG. 7d is a table of sets of inflection suffixes and related words specified by SICs.

FIG. 8a shows a Handheld computer display of the Suffix Set FIG. 8b are stroke assignments for cascades with suffixes from the Suffix Set.

FIG. 8c is a list of four words from starting letters and word ending suffixes.

FIG. 9a is a plan view of a first letter ‘b’ word set on a Handheld computer.

FIG. 9b is a plan view of a 2^{nd} letter SLS ‘ba’ word set on a Handheld computer.

FIG. 9c is a plan view of a two letter SLS ‘ba’ word set on a Handheld computer.

FIG. 10 shows a Desktop computer display of the word set for SLS ‘ab’.

FIG. 11a shows the SLS ‘ab’ word set in the system vocabulary.

FIG. 11b shows the SLS ‘ab’ word set in another form in the system vocabulary.

FIG. 12a shows the composite word set for SLS ‘ba’ and 1^{st} Letter Group of ‘abc’.

FIG. 12b shows the composite word set for SLS ‘ba’ and 7^{th} Letter Group of ‘stu’.

FIG. 13 shows modifications to a part of the functional block diagram of FIG. 1 for a Japanese language model.

FIG. 14 shows the pattern of words and Selectors in a Phonetic Word Vocabulary and in a Kanji Word Vocabulary.

FIG. 15 is a word start presentation for a Japanese language model.

FIG. 16 is a table of the number of Ideographic stroke assignments to strokes with a Pointer.

FIG. 17a is a table of Japanese language post position assignments to strokes with a Pointer.

FIG. 17b is a table of Japanese language verb inflection assignments to strokes with a Pointer.

FIG. 17c is a table of Japanese language adjective inflection assignments to strokes with a Pointer.

FIG. 18 is a table of Japanese demonstration word ending assignments to strokes with a Pointer from roots.

FIGS. 18a and 18b are tables of Japanese Classifier assignments to strokes with a Pointer from Digital display items.

FIG. 20 shows modifications to a part of the functional block diagram of FIG. 1 for a Chinese language model.

FIG. 21 is a word start presentation for a Chinese language model.

FIG. 22 is a word start presentation for a Chinese language model.

### DESCRIPTION OF THE PREFERRED EMBODIMENTS

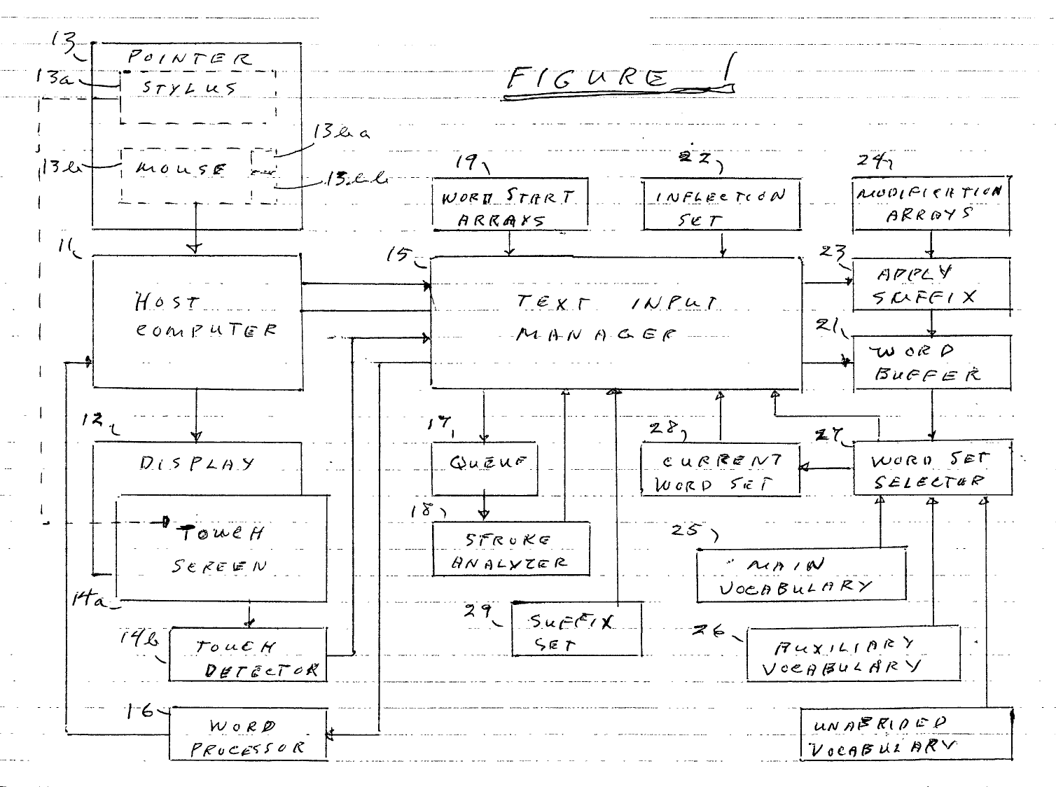

FIG. 1 is a functional block diagram of an embodiment of the instant invention with a Host Computer 11 which may be a Desktop, Laptop, Handheld or other computer with a Display 12 and a Pointer 13. Text Input Manager 15 supplies Computer 11 with data for presentations on Display 12 for text input with Pointer 13. Pointer 13 is any device, such as a Stylus 13a or a Mouse 13b, to designate displayed items. As a Stylus 13a, Pointer 13 uses an accompanying Touch Screen 14a, which overlays a portion of Display 12, and a Touch Detector 14b. which senses the touch of Stylus 13a on Touch Screen 14a. Touch Detector 14b signals Pen Down to Text Input Manager 15 when Stylus 13a touches down on Touch Screen 14a and Pen Up when Stylus 13a lifts from Touch Screen 14a. Touch Detector 14b also signals the ‘x’ and ‘y’ coordinates of the location of Stylus 13a on Touch Screen 14a and a time coordinate to Manager 15. If Stylus 13 moves on Touch Screen 14a, Touch Detector 14b repetitively samples the positions and sends the sampled ‘x’ and ‘y’ and time coordinates to Manager 15. An example of suitable Stylus 13a, Touch Screen 14a and Touch Detector 14b are those used by Palm Computer.

As a Mouse 13b, or other Cursor positioning devices, Pointer 13 works through Computer 11 to position a Cursor on Display 12. The operating system, or OS, such as Microsoft Windows, movers a Cursor about Display 12 in response to moves of Mouse 13b and periodically signals the ‘x’ and ‘y’ screen coordinates of the Cursor to Manager 15. Mouse 13b includes at least two Mouse Buttons 13ba and 13bb and Windows messages to Manager 15 signal operation and release of Mouse Buttons 13ba and 13bb as well ans the ‘x’ and ‘y’ coordinates. Stylus 13a and Mouse 13b thus both designate positions on Display 12 with ‘x’ and ‘y’ screen coordinates to Manager 15. Users can designate displayed items on Display 12 with either Stylus 13a or Mouse 13b. Pointer 13 can be any other device with the capability to position the Cursor and make selections. Mouse 13b has an advantage over Stylus 13a for large displays where the movements of the Cursor can be amplified. Further, Mouse Buttons 13ba and 13bb enable Mouse 13b to select multiple assignments from the same displayed items and from the same actions. On small displays, users move Stylus 13a quickly to any area to nearly touch displayed items for direct selections.

Text Input Manager 15 sends display data to Computer 11 for operation of the input system. On word starts, this data occupies only part of Display 12 to allow viewing of the text document in Word Processor 16. After words starts, Manager 15 uses all of Display 12 for text input data until words are completed. Word Processor 16, which runs on the OS of Computer 11, holds the text document being prepared. Pointer 13 can move the Cursor to the window of Word Processor 16 and transfer control to Word Processor 16 for viewing and editing the text document. Manager 15 produces text input to Word Processor 16 in response to the actions of Pointer 15 received via Computer 11 and to currently displayed data. Manager 15 compares the positions of the displayed data with the screen positions of Pointer 13 received via Computer 11 to determine the displayed item ‘hit’. Manager 15 then acts depending on the ‘hit displayed item assignments. Manager 15 stores the successive position and time inputs produced by movement of Pointer 13 in Queue 17. Stroke Analyzer 18 analyzes the contents of Queue 17 to identify strokes executed by the movements. Stroke Analyzer 18 sends the stroke identities to Manager 15 for various purposes to be discussed later.

Word Start Arrays 19 holds the data for Manager 15 to supply to Display 12 via Computer 11 for word start presentations and other data such as screen positions and assignments. Word Start Arrays 19 may hold the display data in a separate array for Manager 15 to simply copy to Computer 11. Alternatively, Arrays 19 may store the display data as members of structures with other members for display position, text input, etc. Manager 15 then accesses the members in turn for the Display 12 presentation and other members in response to ‘hits’. Word Start Arrays 19 holds the data in various ways to best suit particular embodiments. One embodiment sets up the data as members of structures and then stores the structures in row arrays. When Pointer 13 selects a displayed item, Manager 15 uses the ‘y’ screen coordinate of Pointer 13 to access the appropriate row array and the ‘x’ coordinate to find the structure in the row array with the matching position member. The structure found has the data of the displayed item ‘hit’. Alternatively, the displayed item positions may be such that Manager 15 can calculate an index from the ‘x’ coordinate to directly access the right structure.

Word Start Arrays 19 holds different sets of data for different models as will later be discussed. In general, the data from Arrays 19 provides a plurality of displayed items for selection by Pointer 13. Each displayed item may have more than one text parameter for input assigned, such as a very frequent word, or VFW, and a starting letter string, or SLS. Pointer 13 then both selects the displayed item and indicate which of the assignments is being inputted. Stylus 13a select a displayed item simply by touching down on the Touch Screen 14a over the displayed item location. Stylus 13a requires actions after touchdown, such as execution of a stroke, to designate one of the plurality of assignments for input. Mouse 13b positions the Cursor and operates one of Mouse Buttons 13ba or 13bb to select a displayed item. Mouse Button 13ba, for example, could obtain the word assigned to the selected displayed item and Mouse Button 13bb the SLS assigned. Strokes executed by either Stylus 13a after touchdown or Mouse 13b after selection and identified by Stroke Analyzer 18 perform many functions in addition to indicating which assignment to input. These include adding letters to SLSs and applying inflection suffixes to VFWs and other words.

Manager 15 temporarily stores VFWs and SLSs obtained from Word Start Arrays 19 in Word Buffer 21. Manager 15 may modify or replace the words in Buffer 21 before later inputting the contents of Buffer 21 to Word Processor 16. Manger 15 calls on Word Set Selector 27 to use the SLS inputs to access the next word sets as will later be discussed. The VFWs in Word Start Arrays 19 and words of next sets include codes following the word text or stored as structure members. The word codes may include ‘Digit Letter’ and always include a Stem Inflection Code, or SIC. ‘Digit Letter’ codes specify changes to word stems as necessary to produce irregular inflected forms or related words. The SICs specify the sets of ‘Associated Inputs’ for word stems. The ‘Associated Inputs’ include inflection suffixes to apply to the word stem, related words to substitute for the word stem, and 2^{nd} words to precede or follow the word stem. Inflection Sets 22 holds the sets of inflection suffixes, related words, and 2^{nd} words specified by SICs. When an input by Pointer 13 calls for one of these ‘Associated Inputs’, Manager 15 accessed the one called for from Inflection Sets 22 and performs the actions to input it.

Manager 15 performs some actions itself, such as the substitutions of related words and the additions of 2^{nd} words to Word Buffer 21, but calls Apply Suffix 23 to handle inflection suffixes. Apply Suffix 23 appends inflection suffixes to the word stem in Word Buffer 21 with the proper spelling by changing word stems and inflection suffixes. Apply Suffix 23 uses built-in spelling rules and the combinations of word stem ends and suffix starts in Modification Arrays 24. Modification Arrays 24 holds the modifications of spelling of word stem and suffix combinations not handled by spelling rules. Apply Suffix 23 in combination with Modifications Arrays 24 accomplishes most of the often complex changes necessary to combine word stems and inflection suffixes with the proper spelling. ‘Digit Letter’ codes handle particular instances which cannot efficiently be handled by Modification Arrays 24 or which involve conflicting alternates for the same endings. (Apply Suffix 23 and Modification Arrays 24 are described in more detail in applicant's prior patents.)

Main Vocabulary 25 holds word stems for the word sets to follow word starts. In some models, Vocabulary 25 has the word stems organized into sets by frequency of use and sized for the Host Computer 11. In other models. Vocabulary has the word stems of an abridged dictionary arranged in strings. Auxiliary Vocabulary 26 holds such special words as technical or scientific terms, custom Proper Nouns, etc. Unabridged Vocabulary 30 holds the words of an unabridged dictionary less the words in Vocabularies 25 nd 26. For most SLS inputs, Manager 15 calls Word Start Selector 27 to obtain the word set for the SLS in Main Vocabulary 25. (Special input actions have Manager 15 directing Word Set Selector 27 to access Auxiliary Vocabulary 28 an Unabridged Vocabulary 30 instead.) Selector 27 accesses word sets in Vocabulary 25 and copies them to Current Word Set 28 along with SLS and next letter Markers. Manager 15 handles the data in Current Word Set 28 as in Word Start Arrays 19, copying display data to Computer 11 for presentation on Display 12 and determining displayed items ‘hit’. The display data consists of the words of the set obtained from Vocabulary 25 and the ‘Markers’ added by Selector 27. As on word starts, Pointer 13 selects wanted words and Manager 15 handles the selected words, processing some changes and using Apply Suffix 23 and Modification Arrays 24 for others.

The word stems from Vocabularies 25, 26 and 30 may have ‘Digit Letter’ codes and SICs as described for VFWs. Word Set Selector 27 adds ‘Markers’ to selected word sets to show SLSs and next letter changes. Vocabulary 25 may hold the word stems complete so Selector 27 merely has to copy them. Alternatively, Vocabulary 25 may omit repeats of starting letters to save memory space, as in applicant's prior patents. Selector 27 then fills in the starting letters as it copies the word stems to structure member slots in Current Word Set 28 and perhaps to Computer 11 for Display 12 as well. As it copies, Selector 27 keeps track of the number of letters and characters to be displayed in each row. Selector 27 puts the count accumulated to each word in the row position member for the word in Current Word Set 28. Manager 15 uses the row position members to determine the word and perhaps the letter or character of the word ‘hit’ by Pointer 13.

FIG. 1 further has a Suffix Set 29. Manager 15 obtains most of the inflection suffixes to produce inflected forms of word stems from the codes with the word stems. When other suffixes are needed, users are able to enable Suffix Set 29. Suffix Set 29 holds a complete set of inflection suffixes and some word ending suffixes useful in completing words. Manager 15 responds to input actions by Pointer 13 enabling Suffix Set 29 by copying its display data to Computer 11 for presentation on Display 12. Users can then select suffixes from Suffix Set 29 with Pointer 13. Manager 15 appends some selected suffixes directly to the currently selected word and calls Apply Suffix 23 to handle others. Manager 15 directs Selector 27 to switch the search to Auxiliary Vocabulary 26 on execution of special strokes and to Unabridged Vocabulary 30 upon input of additional letters.

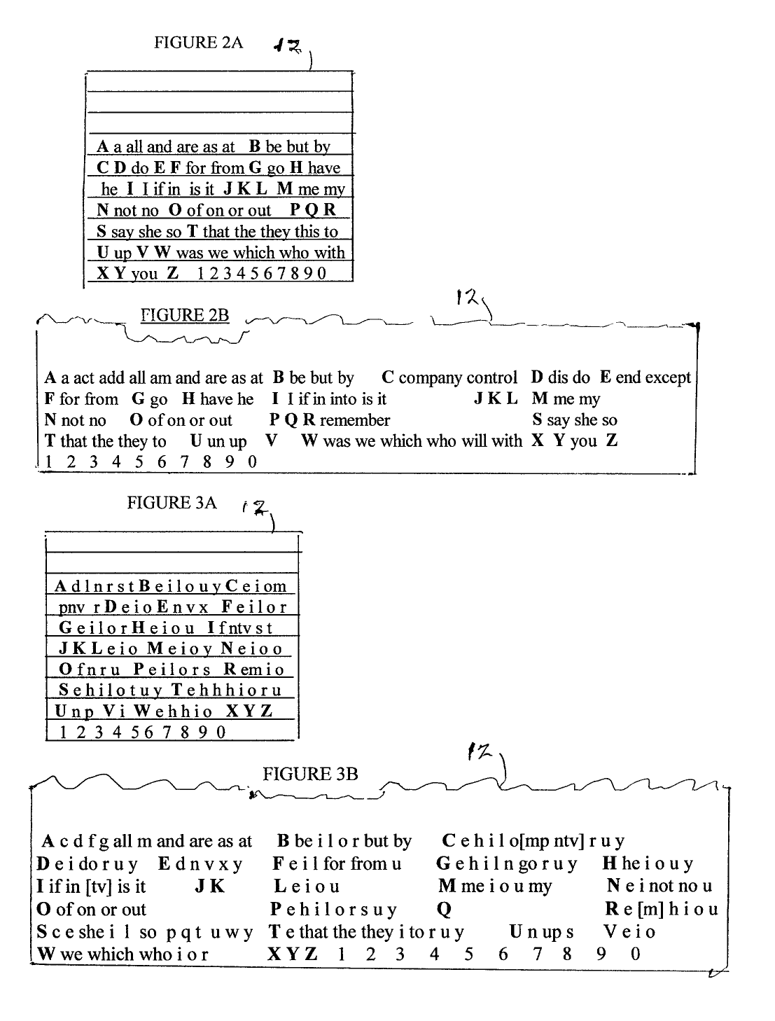

FIGS. 2a, 2b, 3a, 3b and 3c show five different word start presentations, FIGS. 2a and 3a, for Handheld computers; FIGS. 2b, 3b and 3c for Desktop and Laptop computers. All presentations include ten Digits and 26 capitalized starting letters, or SLs, and either or both VFWs and lower case letters as displayed items. The Digits each have eight number values and number words for input. Strokes from a Digit select the inputs other than the respective digit. The SLs mark display areas for the remaining displayed items for words starting with the respective letters. The other displayed items for FIGS. 2a, 2b, and 3c are VFWs and for FIGS. 3a and 3b primarily 2^{nd}, 3^{rd} and 4^{th} letters which append to the SL for SLSs. FIGS. 3a, 3b and 3c and FIG. 2b in Mode II assign both VFWs and SLSs to displayed items. The displayed items representing SLSs have VFW inputs which are the most frequent words with the respective SLSs. The displayed VFWs have their SLSs as SLS inputs.

Strokes with Pointer 13 after selection of displayed items obtain additional inputs or actions. Mouse 13b uses Mouse Buttons 13ba and 13bb for VFW and SLS inputs respectively. Strokes have different sets of assignments with different buttons and button combinations. Stylus 13a obtains VFW inputs with taps and SLS inputs with strokes after touch down. Stylus 13a employs different types of strokes for different sets of assignments. Stroke assignments include ‘Associated Inputs’ of VFWs, ‘Letter Groups’ to extend SLSs; punctuation and other word endings. ‘Associated Inputs’ include inflected forms of word stems, sets of related words, and 2^{nd} words. Strokes also obtain single letter inputs, switch access to Auxiliary Vocabulary 26 and to Unabridged Vocabulary 30.

The first, and simplest, Handheld model uses the FIG. 2a word start presentation which occupies the lower seven rows of Display 12 of a Handheld computer and leaves four rows for the text document being prepared in Word Processor 16. The presentation consists of the SLs, the Digits and 43 VFWs and the pointing means is a Stylus 13a. If the word wanted is a displayed VFW, Stylus 13a taps on it, Manager 15 puts it in Word Buffer 21 on touch down and transfers it to Word Processor 16 on lift off. For other words, Stylus 13a taps on the SL of the wanted word. Manager 15 puts the letter in Buffer 21 and calls Word Set Selector 27 to access Main Vocabulary 25 for the word set assigned to the letter in Buffer 21. Selector 27 copies the word set accessed to Current Word Set 28, adds 2^{nd} letter Markers. Manager 15 then transfers the contents of Current Word Set 28 to Display 12 via Computer 11. Users look for the word wanted by first locating the Marker matching the 2^{nd} letter of the word and then looking for the word in the group. If the word wanted is a stem, a tap with Stylus 13a ion the word stem has Manager 15 putting it in Buffer 21 on touch down and inputting it to Word Processor 16 os lift off.

If the wanted word is an inflected form or other ‘Associated Input’ of a word stem, the user puts Stylus 13a on the word stem and then executes the stroke for the word. After putting the word stem in Word Buffer 21, Manger 15 controls the processing to change the contents of Buffer 21 to the appropriate inflected form or other ‘Associated Input’. While Stylus 13a moves, Manager 15 periodically puts the ‘x’ and ‘y’ coordinates from Touch Detector 14a in Queue 17. Stroke Analyzer 18 responds to the successive positions by identifying the stroke executed to Manager 15. Manager 15 used the stem inflection code of the word stem either to obtain the inflection set called for from Inflection Sets 22 or to change the stem according to a ‘Digit Letter’ code. The codes and the operations will be discussed later. Manager 15 handles ‘Digit Letter’ codes itself but calls Apply Suffix 23 to apply inflection suffixes. The same actions apply when the ‘Associated Input’ of a VFW is wanted. Beginners can pause with Stylus 13a on VFWs or word stems to obtain a pop up display of their ‘Associated Inputs’.

Strokes from VFWs and from word stems obtain ‘Associated Inputs’ as just described. As previously stated, a tap with Stylus 13a on an SLs has Manger 15 putting the respective letter in Word Buffer 21 on touch down and calling Word Set Selector 27 on lift off. Strokes with Stylus 13a from an SL has Manager 15 input letters individually or switch access to Auxiliary Vocabulary 26. The first letter word sets have 2^{nd} letter Markers to assist searches for wanted words. If the wanted word is not present in a word ste, a tap on a next letter Marker has Manager 15 adding the letter to Word Buffer 21 calling on Word Set Selector 27 to obtain another word set. As with other presentations, taps on Digits input the respective digit and following strokes select the respective digit related values and words.

The FIG. 2b word start presentation for Laptops and Desktops shows the same data as FIG. 2a, along with some additional VFWs, on four rows of Display 12. The rest of Display 12 presents the text document in Word Processor 16. A Mouse 13b or other Cursor positioning Pointer 13 conveniently covers the larger Display 12. Except for the differences in Stylus 13a and Mouse 13b operations, the first Laptop and Desktop model operations are substantially the same as for the first Handheld model. Second Laptop and Desktop models also use FIG. 2b but operations are quite different. Displayed items have both VFW and SLS assignments and Main Vocabulary 25 holds strings of the word stems of an abridged dictionary instead of word sets. Mouse 13b positions the Cursor on a VFW and operates Button 13ba to have Manager 15 input the VFW as previously described. Operation of Button 13bb instead has Manager 15 using the first two letters of the VFW as an SLS input. Manager 15 puts the SLS in Buffer 21 and calls Word Set Selector 27 to obtain words with matching SLSs from the word stem strings of Main Vocabulary 25. Selector 27 adds SLS and 3^{rd} letter Markers to the words as it copies them to Current Word Set 28 for relay by Manager 15 to Display 12 via Computer 11.

When Button 13ba operates with the Cursor on an SL, Manager 15 obtains the VFW assigned to the SL and inputs it as previously described. Button 13bb obtains the first two letter SLS to be handled as previously described. Execution of strokes with Button 13ba operated has Manager 15 modify the VFWs in Word Buffer 21 with the ‘Associated Input’ selected. Execution of strokes with Button 13bb operated has Manager 15 adding the ‘Letter Group’ selected to the SLS. ‘Letter Groups’ and their extension of SLSs will be discussed later. In some cases, the result is more than one SLS. Selector 27 handles each SLS in obtaining a composite word set with a Marker for each SLS.

Manager 15 responds to a ‘hit’ on a VFW in the FIG. 2a or 2b presentations by a Stylus 13a or a Mouse 13b as Pointer 13 by copying the VFW to Word Buffer 21. Manager 15 transfers the VFW from Buffer 21 to Word Processor 16 on lift of Stylus 13a or on release of Mouse Button 13ba or 13bb. If Stroke Analyzer 18 identifies a letter stroke following selection of an SL by Stylus 13a or Mouse 13b, Manager 15 places the respective SL and the letter from the stroke in Word Buffer 21. Manager 15 next calls Word Set Selector 27 to find the word set in Vocabulary 25 for the SLS in Buffer 21. Word Set Selector 27 access the word set and transfers it from Vocabulary 25 to the Current Word Set 28 along with SLS and next letter Markers. Manager 15 copies the display data in Current Word Set 28 to Computer 11 for presentation on Display 12. If a particular stroke precedes Stylus 13a lift off or release of Button 13ba or 13bb, Manager 15 places the starting letter in Word Buffer 21 and directs Selector 27 to instead access the word set assigned to the starting letter in Auxiliary Vocabulary 26. The VFWs available with single inputs from the FIG. 2a and 2b presentations comprise roughly 45% of the words of the average text document.

The second Handheld model has the FIG. 3a word start presentation on the lower eight rows of Display 12, leaving three rows for the text document. FIG. 3a includes the SL and the Digits of FIGS. 2a and 2b but has lower case letters instead of VFWs as displayed items. The lower case letters and the ‘Spaces’ between the letters represent 2^{nd} letters, alphabetic ranges of 2^{nd} letters and a few 3^{rd} and 4^{th} letters of SLSs. A few lower case letter represent VFWs Stylus 13a obtains SLS and VFW inputs from the displayed items. The VFWs are the most frequent words with the respective SLSs. FIG. 3b for the corresponding Laptop and Desktop models has the displayed items of FIG. 3a with a few more lower case letters and VFWs added to better indicate the inputs available. Upon selection of a capitalized letter, Manager 15 directs Selector 27 to access the start of the string for the respective letter in Vocabulary 25. The result is generally the same as for the first two letter SLSs. The ‘A’, for example, obtains ‘aa’ and, as there are few words starting with ‘aa’, Selector 27 also obtains the words starting with ‘ab’. The VFW for ‘A’ is “a”.

In FIG. 3a, the ‘Spac’ after ‘A’ has the next two letter SLS, ‘ac’ and “act” as the VFW. In FIG. 3b, ‘c’ as a 2^{nd} letter more clearly indicates the SLS obtained. FIG. 2a uses the ‘Spaces’ for assignments to fit the presentation on Handheld computers. The assignments proceed in alphabetic order in most cases so it is easy to predict the 2^{nd} letter ‘Spac’ assignments. In FIG. 3a, the next 2^{nd} letter after ‘d’ in the ‘A’ area is ‘l’ and FIG. 3b has ‘f’ in the same location. The assignment for the ‘Spac’ in FIG. 3a and the ‘f’ in FIG. 3b is the alphabetic range of 2^{nd} letters from ‘f’ to ‘k’ and the VFW is “after”. Input of the 2^{nd} letter range has Selector 27 collecting the words with SLSs of ‘af’, ‘ag’, ‘ah’, ‘ai’, ‘aj’ and ‘ak’. The few words starting with each of these SLSs constitute a modest sized composite word set. Selector 27 inserts SLS Markers to separate the words with the different SLSs into groups and next letter Markers in each group as it copies the composite set to Current Word Set 28. The alphabetic range inputs reduce the numbers of inputs necessary to obtain all words. A few lower case letters are the 3^{rd} or ^{th} letters of SLSs. FIG. 3a presents them without separating ‘Spaces’ and FIG. 3b encloses them in ‘[ ]’s. The way in which they are handled by Manager 15 and Selector 27 will be discussed later.

FIG. 3c, an alternative word start presentation for Desktop computers, has a large number of VFWs along with the capitalized letters and digits of the other word start presentation. The VFWs are generally the most frequent words with the SLSs and the accompanying VFW inputs of FIGS. 3a and 3b. In FIG. 3c, the displayed VFWs have accompanying SLS assignments consisting of their starting letters or SLSs. Pointer 13 positions the Cursor, or touches down, on a VFW to selects both the VFW and its SLS. Mouse Buttons 13ba and 13bb, or action with Stylus 13a after touch down designate either the VFW or the SLS for input. Manager 15 handles VFWs as before and SLSs by putting just the SLS of the VFW in Word Buffer 21 before calling Word Set Selector 27.

The FIG. 3a, 3b, and 3c presentations all provide SLS inputs to access all of the word stems from Main Vocabulary 25 in sets displayable on Desktop computers. (As previously mentioned, Main Vocabulary 25 of these embodiments hold strings of the word stems of an abridged dictionary.) FIG. 3a, however, has a presentation for a Handheld computer and Pointer 13 will most likely be a Stylus 13a using movement for SLS inputs. As will later be discussed, strokes are used for the distinguishing movement and for extending the SLSs to obtain smaller word set displayable on Handheld computers. FIGS. 3a, 3b and 3c also provide VFW inputs comprising roughly half of the words of average text documents.

With FIGS. 2a, 2b, 3a, 3b and 3c, the starting letter of a wanted word directs the user to the display area marked by the respective capitalized letter for input of the VFW or SLS starting with that letter. The next step is to find the 2^{nd} letter of the wanted word, whether presented as a displayed item, a ‘Spac’ or in a VFW. Beginners can pause with Pointer 13 to obtain a pop up display showing the assignments of any location including any ‘Associated Inputs’ of the VFWs. The VFWs and their ‘Associated Inputs’ are shown at the start of word sets obtained from the SLS inputs so beginners can just make SLS inputs while learning the VFW assignments.

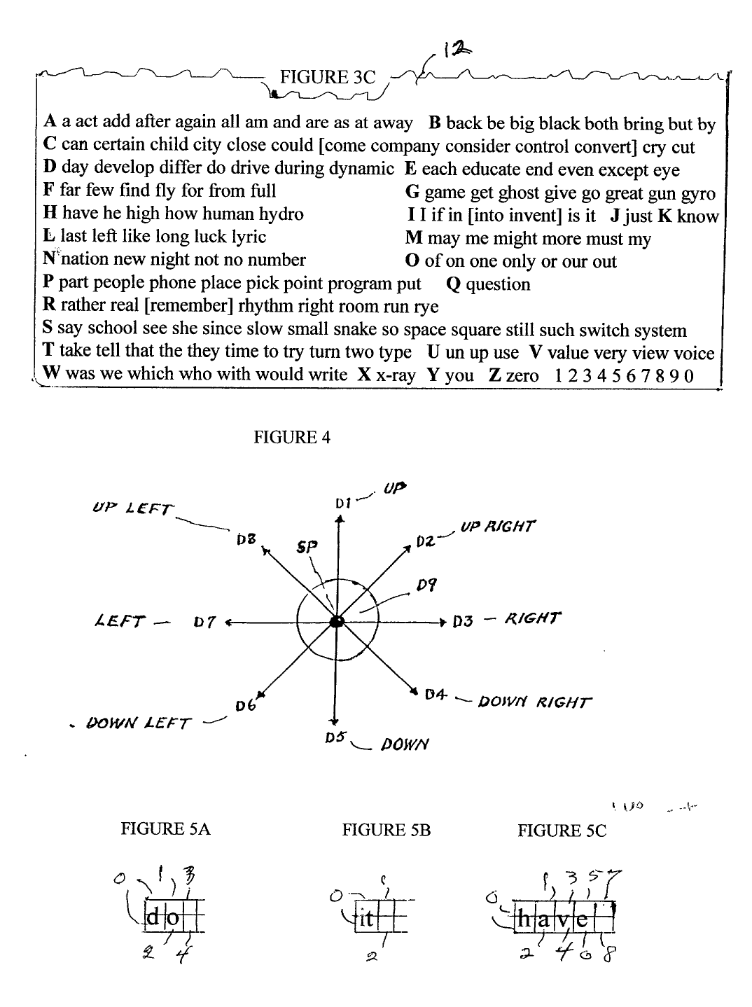

FIG. 4 is a sketch showing arrows in eight directions ‘D1’ through ‘D8’ and a circle about the origin ‘O’ labeled ‘D0’. The directions running clockwise, D1 through D8, are labeled ‘Up’, ‘Up Right’ ‘Right’, ‘Down Right’, ‘Down’ ‘Down Left’, ‘Left’ and ‘Up Left’. The 12, 1:30, 3, 4:30, 6, 7:30, 9, and 10:30 positions on a clock face also represent D1 through D8 respectively. Users can easily master executing straight strokes in these eight directions by establishing and maintaining ‘Up’, or 12 o'clock, as a reference for pointer locations. Eight straight strokes from any display screen position potentially multiplies the number of inputs by eight.

Applicant's prior patents found a need for more than eight strokes is a somewhat different environment and employed curved clockwise, or CW, and counter clockwise, or CCW patterns along with straight. The patents also suggest changes in length or speed to further increase the number. The instant invention employs Stylus 13a to not only move along the surface but to ‘Hop” in any directions as well. A ‘Hop’ up and down landing inside the circle ‘D0’ is the ninth ‘Hop’ labeled ‘D0’. ‘Hops’ might be executed with a Mouse 13b but not as easily. Mouse 13b, however, has Buttons 13ba and 13bb which can individually and in combination enable different sets of stroke assignments. ‘Hops’ are good for adding inputs, such as punctuation, that do not affect prior inputs as the program has to wait for the end of the ‘Hop’.

The instant invention adds further variations in straight stroke patterns in search of the those easiest to execute. Starts for selection actions by Stylus 13a are touchdowns and by Mouse 13b are operations of Buttons 13ba and 13bb. Strokes can start and end with these Pointer 13 ‘starts’ and ‘ends’ or can delay starting after a ‘start’ and can end movement before an ‘end’. Stroke Analyzer 18 receives time coordinates as well as position coordinates with Pointer 13 events and movements and so can easily determine the differences in start and end timing. The several patterns for eight straight strokes, Right On, or RO, Start Delay, or SD, End Advance, or EA, and SD with EA, or SDEA, yields a total 32 strokes. Combined with screen locations and Mouse Buttons 13ba and 13bb, strokes with these patterns can rapidly handle many inputs.

FIGS. 5a, 5b, and 5c are plan views of the FIGS. 2a, 2b, and 3c display areas of ‘do”, “if” and “have” divided into upper and lower character ‘Sections’ for ‘Associated Input’ assignments. If the display characters are of a cone ant width font, the same size ‘Sections’ would be associated with each letter. In the case of a variable width font, such as that employed by Palm computers, the ‘i’ and ‘f’ of “if” are combined and the ‘Spac’ is doubled for ‘Sections’ for the convenience of users. (Touch Screen resolution could handle the smaller ‘Sections’.) After the first letter, ‘Section’ 0, ‘Sections’ are numbered ‘1’ to as high as ‘8’ to correspond to the D1 to D8 strokes of FIG. 4. Touchdown on a ‘Section’ with Stylus 13a, or selection with Mouse 13b, obtains the assignment of the ‘Section’ just as does the respective one of strokes D1 through D8. ‘Sections’ of displayed VFWs and words thus obtain the ‘Associated Inputs’ of VFWs and words. ‘Sections’ require additional precision of touch down, the strokes an interval for movement Users can employ either or use strokes as back up to override ‘Section’ touch down errors.

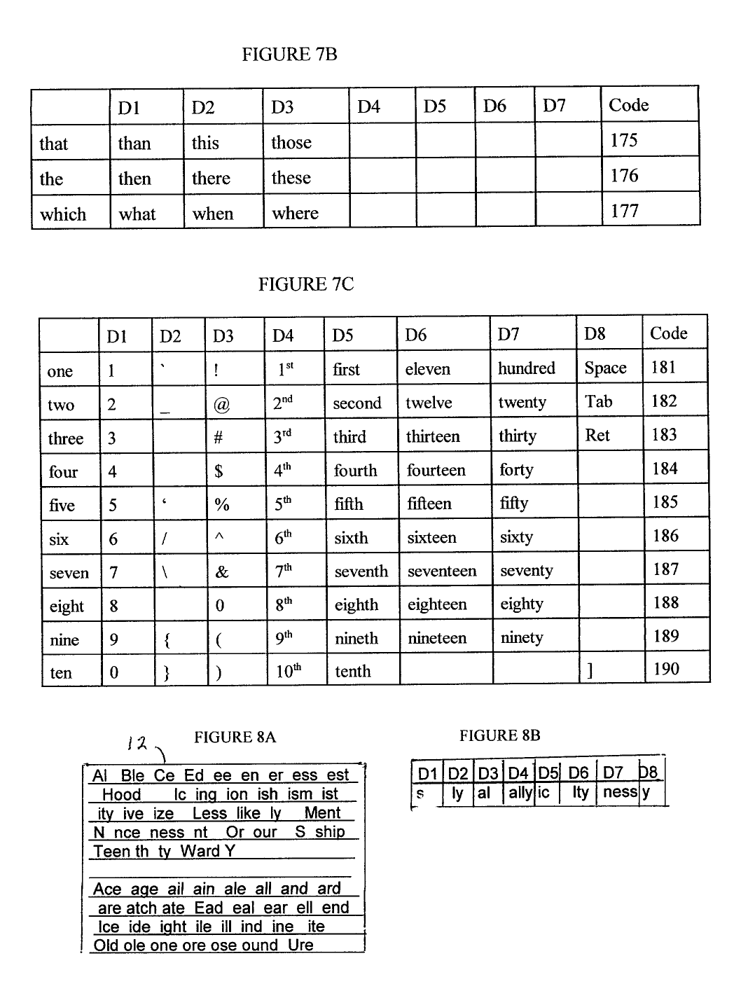

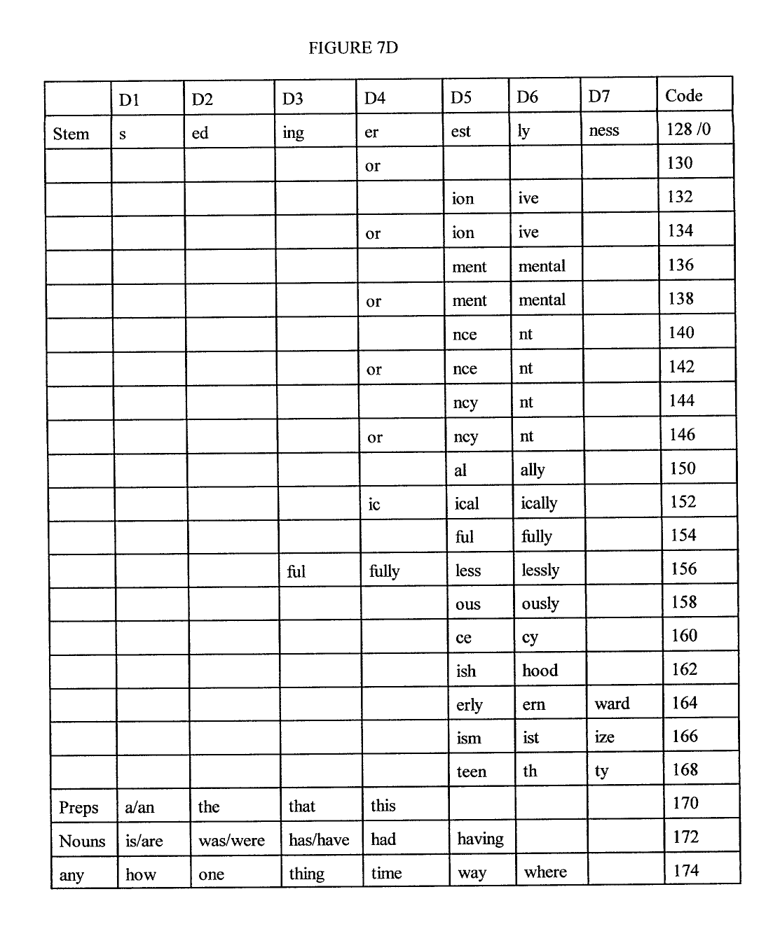

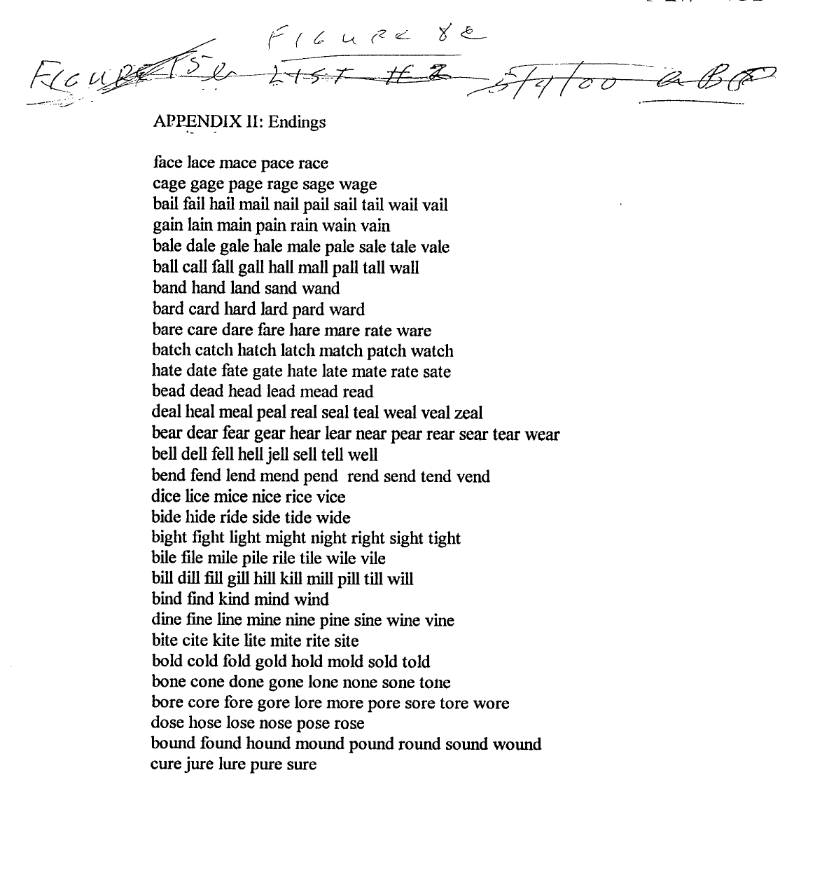

‘Sections’ 1 through 8 have the same assignments as Strokes D1 through D8. In response to touchdown on a ‘Section’ or execution of a stroke, Manager 15 first checks the code of the relevant VFW or other word. If there is a ‘Digit Letter’ code 1 the selection, Manager 15 applies the ‘Digit Letter’ code. If no SIC or a value of 128, Manager 15 uses the selected member of the standard set of inflection suffixes. Else Manager 25 looks up the SIC specified inflection suffix set in Inflection Sets 22 to obtains the selected member. In either case, Manager 15 next calls Apply Suffix 23 to apply the selected inflection suffix. As “do” and “have” are both irregular verbs with ‘Digit Letter’ codes, it is necessary to first discuss ‘Digit Letter’ codes which have priority over standard and SIC specified suffix sets. The ‘Digit Letter’ codes of “do” and “have” are among those in the last column of FIG. 7a.

‘Digit Letter’ codes specify changes in word stems to form irregular inflections or just another word. Each ‘Digit Letter’ code consists of one or two digits followed by one or more letters. When there are two digits, the first digit is the number of the ‘Section’ or stroke to which it applies. The first digit is are for codes follow other in order and for the 2^{nd} ‘Section’ or stroke. 2^{nd}, or only, digits specify the number of letters to be omitted from the end of the stem before appending the letter string of the code. By way of example, the ‘Digit Letter’ code for “d ”, as shown in FIG. 7a, is ‘0eslid60ne. The first code, ‘0es’, is for ‘Section’ 2 or Stroke D2. The ‘0’ calls for omitting ‘0’ letters from “do” before appending ‘es’. The result is “loes”. The second code, ‘lid’, for ‘Section’ 3 or stroke D3, has ‘1’ omitting the last letter of “do” before adding ‘id’ to obtain “dl”. The last code, ‘60ne’ is for ‘Section’ 6 stroke D6 as specified by the 6′. The ‘0’ specifies no letters to be omitted from “do” before appending ‘ne’ to obtain “done”. ‘Sections’ 4 and 5 and strokes D4 and D5 have no ‘Digit Letter’ code and so obtain the standard suffixes ‘ing’ and ‘er’ respectively for “doing” and “doer”. For “have’, ‘2s2d’ similarly obtains “has’ for ‘Section’ 2 or stroke D2 and “had” for ‘Section 3 and stroke D3 by deleting ‘ve’ for ‘2’ and appending ‘s’ and ‘d’ respectively.

The VFW “if” has SIC of 170 which specifies a set of 2^{nd} Words' as shown in FIG. 7a. ‘2^{nd} Words’ are words which precede or follow a word stem, in this case follow. Instead of applying a suffix, Manager 15 first inputs the word and then the ‘2^{nd} Word’. One user input action thus obtains two words. The entry of ‘a/an’ represents “a” or “an” as the ‘2^{nd} Word’. Whether “a” or “an: depends on the starting letter or sound of the next word. Manager 15 inputs an ‘a’ after “if” and then adds an ‘n’ for “an” if the next word starts with a vowel or with a vowel sound. The later include words starting with ‘h’ such as “hour”, “herb”, “honor”, and “honest”. Also included are capitalized letter sequences, such as ‘FCC’, if the first letter is pronounced with a vowel sound, as do the following: AEFILMNOSUXZ. The entry ‘a/an’ thus serves for both “a” and “an”.

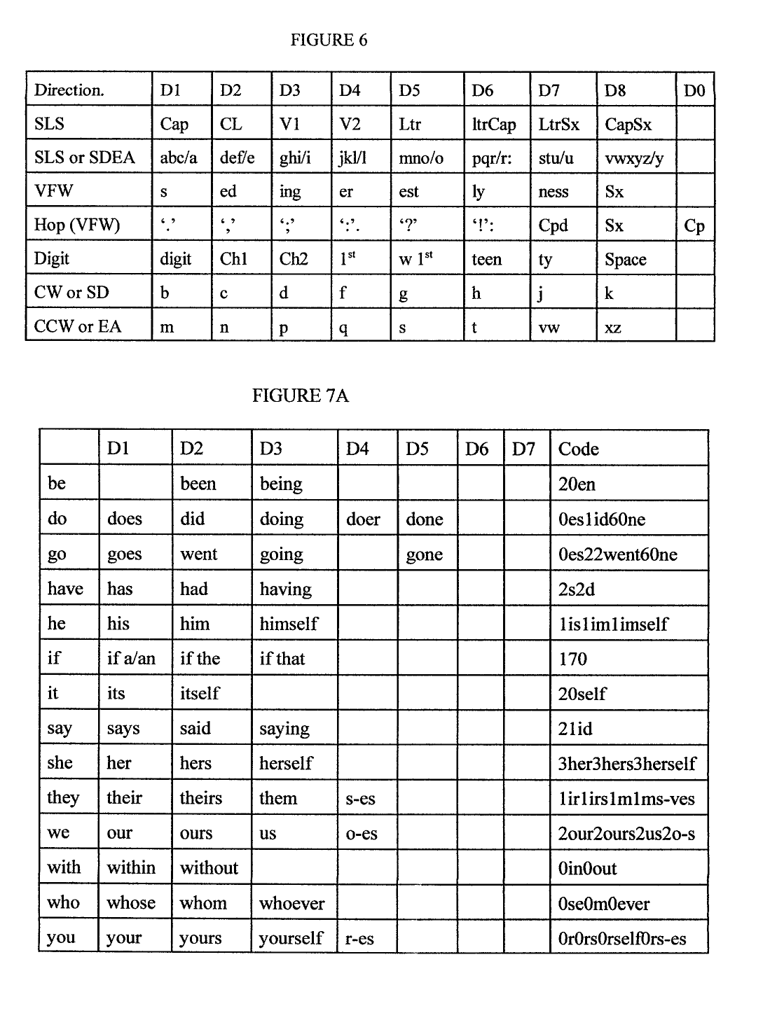

FIG. 6 has the most common assignments for strokes. ‘Sections’ of VFWs and other word stems may optionally cover some of the assignments for VFWs and words. The first row assignments are other inputs from the SL displayed items. ‘Cap’ capitalizes the first letter and ‘CL’ all of the letters of the word next obtained from the word set accessed by the letter input. ‘V1’ and ‘V2’ switch access by the letter from Main Vocabulary 25 to modules of Auxiliary Vocabulary 26. ‘Ltr’ inputs the letter as a letter. ‘LtrCap’ inputs the letter as capitalized. ‘LtrSx’ inputs the letter, and ‘CapSx the capitalized letter, together with enablement of the appending of suffixes, to later be described. Manager 15 changes its input responses to perform the functions necessary to handle these new input actions.

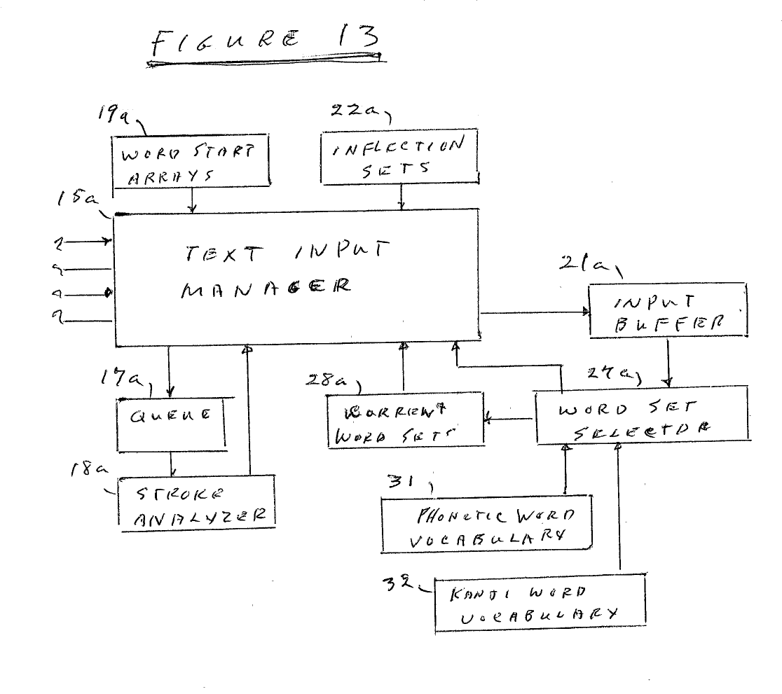

The second row shows eight ‘Letter Groups’ which enable eight strokes to effectively extend SLs and SLSs. Manager 15 responds to ‘Letter Groups’ by adding each letter of their respective sets to the SLs of FIGS. 2a and 2b and to the selected SLSs of FIGS. 3a, 3b and 3c and putting each of the resulting longer SLSs in temporary storage. (The user has to select the ‘Letter Group’ that includes the next letter of the wanted word.) Selector 27 handles each the multiple SLSs resulting from a ‘Letter Group’ input in alphabetic order. Selector 27 discards SLSs if it finds no words with a matching SLS. In the case of the starting consonant letters or consonant ending SLSs, the only one letter of each ‘Letter Group’ results in an SLS that start words. These are the single vowel and vowellike letters of each ‘Letter Group’. In this case, ‘Letter Group’ inputs have the same result as single letters. In other cases, two, and sometimes three, SLSs have matching words. Selector 27 inserts an SLS Marker ahead of the next letter Markers and matching words of each in a still small composite word set for Current Word Set 28. (Examples shown in FIGS. 12a and 12b will be discussed later.)

Adding the next letters individually requires 24 or more strokes. The single vowel and vowellike letters of each ‘Letter Group’, shown following the ‘/’s, replace the ‘Letter Groups’ as the straight stroke, assignments, or become the SDEA assignments. The last two rows of FIG. 6 assignments for CW, or SD, and CCW, or EA, strokes cover the remaining letters with two pairs, ‘wx’ and ‘yz’. Some may prefer this 24 stroke alternative inputting generally individual letters to the ‘Letter Group’ inputs with eight strokes.

The third set of assignments of FIG. 6 are the standard set inflection suffixes and the ‘Sx’ input to enable adding more suffixes. This is the default set of inflection suffixes for words with no SIC or with an SICs of 128. The members of this set are replaced by ‘Digit Letter’ codes for their respective slots and by any different members of other sets specified by other SICs. When displayed items have both SLS and VFW assignments, Stylus 13a has to employ different stroke patterns for ‘Letter Group’ inputs to extend SLSs and for the ‘Associated Inputs’ replacing VFWs. The different patterns may be curved CW or CCW or SD or EA or SDEA. As Mouse 13b distinguishes SLS and VFW inputs with operation of different ones of Buttons 13ba and 13bb, it can employ straight strokes for both ‘Letter Groups’ and ‘Associated Inputs’.

The fourth set of assignments of FIG. 6 adds endings, such as punctuation, to follow completed VFWs, or ‘Associated Inputs’, or other word inputs. The punctuation character members append ‘Punctuation Strings’ to the words consisting of the respective punctuation characters, the appropriate number of ‘Spaces’, and automatic capitalization of sentence starts. The ‘Cpd’ input compounds the word with the last word inputted. The ‘Sx’ input enables the application of suffixes from Suffix Set 29 to the word. The ninth ‘Cp’ input sets up compounding of the next word with the current word. Stylus 13a employs ‘Hops’ to unambiguously obtain these assignments. Mouse 13b operates both Buttons 13ba and 13bb and employs straight strokes. ‘Hops’ cover all nine assignments but Mouse 13b has to get by without the ninth assignment, not too serious as it is only an alternative way to compound words.

FIG. 7a shows irregular ‘Associated Inputs’ of many more of the VFWs of FIGS. 2a, 2b, and 3c obtainable by ‘Section’ or stroke selection as just described for “do” and “have”. The various ‘Digit Letter’ codes also work as previously described. (The entries of “themselves”, “ourselves” and “yourselves” and their codes are abbreviated to fit table slots.). If VFWs are not displayed, there are no ‘Sections’ and ‘Associated Inputs’ can only be obtained with strokes. FIG. 7b shows sets of very frequent words starting with ‘th’ and ‘wh’ to supplement the single VFWs of the ‘th’ and ‘wh’ SLSs. Making the words ‘Associated Inputs’ of VFWs “that”, “the”, and “which”, using with SICs 175, 176, and 177 respectively, makes them obtainable by stroke on first actions. FIG. 7c shows the ‘Associated Inputs’ for each of the digits of FIGS. 2a, 2b, 3a, 3b, and 3c obtainable by stroke after selection of the respective digit. Many of the words quality as VFWs and the values are useful text document entries.

FIG. 7d is a general list of the sets of inflection suffixes specified by SICs and stored in Inflections Sets 22. The odd numbered SICs, not shown, have the same set of inflection suffixes as the preceding SIC but also specify non-doubling of final consonants of word stems with the appending of vowel starting suffixes. SICs 170 and 172 have 2^{nd} word assignments for word stems without inflected forms or other ‘Associated Inputs’. SIC 170 serves for prepositions and other words frequently followed by ‘a/an’, ‘the’, ‘that’ and ‘this’. Manager 15 inputs the respective word stems and then the word assigned to an executed stroke. The result is input pairs of words with single actions. SIC 172 similarly enables adding singular or plural very frequent verbs after nouns and pronouns. SIC 174 has a set of words to compound with ‘any’ and ‘some’. SICs 175, 176, and 177 for sets of words starting with ‘th’ and ‘wh’ have been previously discussed. SIC 178 is a set of inflection suffixes which Manager 15 enables for cascading with strokes following selections of ‘Associated Inputs’ or for applying to word stems after selection. The large number of alternative suffixes specified by the SICs are assigned to strokes D5 and D6. User wanting one of these suffixes can be assured it will be there if the stem in fact uses it for an inflected form.

FIG. 8a shows Suffix Set 29 presenting inflection suffixes on the upper five rows of a Handheld computer display and word ending suffixes on the lower four rows. When a user selects the ‘Sx’ assignment of a ‘Section 8 or a stroke D8, Manager 15 copies the contents of Suffix Set 29 to Computer 11 to produce the FIG. 8a presentation on Display 12. Manager 15 responds to a ‘hit’ on an inflection suffix by calling Apply Suffix 23 as it does for inflection suffixes from Inflection Sets 22. FIG. 8b shows a set of assignments of suffixes and suffix cascades for strokes D1 through D8 executed after selection of an inflection suffix of FIG. 8a. These assignments append to the selected suffix so cascades are obtained with single actions. Users select ‘Sx’ when the suffix wanted is not in the SIC specified set or when they want a suffix cascade.

The word ending suffixes of Suffix Set 29 are not needed where Main Vocabulary 25 has all of the words of an abridged dictionary. The FIG. 2a word start presentation does not provide inputs to access all of the words of an abridged dictionary in sets displayable on Handheld computers. FIG. 2a requires Vocabulary 25 to be limited by further abridging or by being composed of word sets sized for Handheld computers. In either case, the word endings are useful for appending to starting letters to form many four and five letter words not frequent enough to be included in the word sets of a limited Vocabulary 25. As shown in FIG. 6, executing stroke D7 or D8 inputs an individual letter and enables the application of suffixes. Manager 15 puts the letter, alone or following previously inputted letters, in Word Buffer 21 and copies Suffix Set 29 to Display 12 via Computer 11. Manager 15 then responds to selection of a word ending suffix by appending it to the contents of Buffer 21. Single letters and the word ending suffixes thus produce the words listed in FIG. 8c.

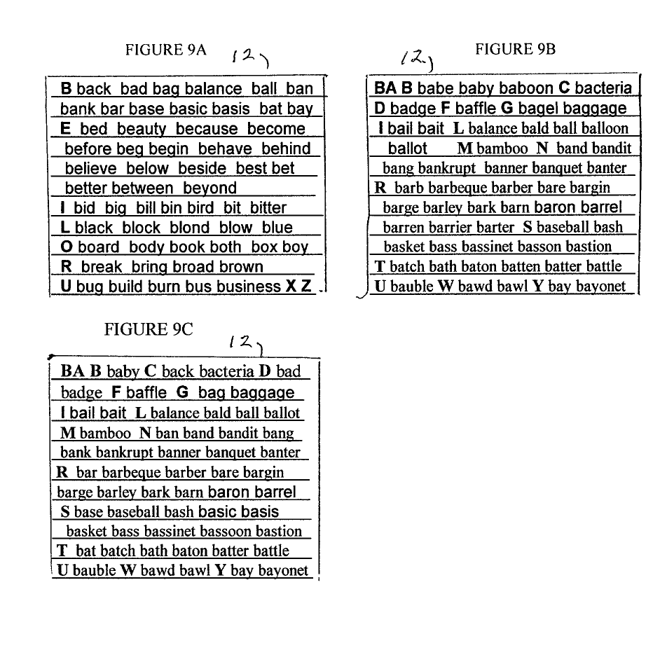

FIG. 9a shows the next letter Markers and words of a first letter set starting with touching down on SL ‘B’ of FIG. 2a. (For this embodiment, Vocabulary 25 has word sets tailored for Handheld computers.) Manager 15 and Word Set Selector 27 respond to the input action by accessing a first letter ‘b’ word set from Vocabulary 25 and copying it to Current Word Set 28 with the insertion of next letter Markers. Manager 15 then copies the contents of Current Word Set 28 to Display 12 via Computer 11 and obtains the FIG. 8a presentation. The 2^{nd} letter Markers break the set into groups for easier searching but there are still many words in the groups starting with ‘ba’ and ‘be’. If the word is not found, input a 2^{nd} letter ‘a’ by tapping on the next letter ‘A’ Marker. Manager 15 adds ‘a’ to the ‘b’ already in Word Buffer 21 and calls Selector 27 to access the word set in Vocabulary 25 assigned to ‘ba’. Selector 27 inserts SLS and 3^{rd} letter Markers as it copies the ‘ba’ word set to Current Word Set 28. Again, Manager 15 transfers the contents of Current Word Set 28 to Display 12 via Computer 11. FIG. 8b shows the result on Display 12.

Alternatively, users can input ‘ba’ by touching down on ‘b’ of FIG. 2a and executing straight stroke D1 for the first ‘Letter Group’. (The ‘Letter Group’ set accessed by Stroke D1 consists of the letters ‘abc’ as shown in FIG. 6.) Manager 15 then puts ‘ba’, ‘bb’ and ‘bc’ in Word Buffer 21 and calls Selector 27 to access words starting with those SLSs from Main Vocabulary 25. There are, of course, no words starting with ‘bb’ or ‘bc’ in Vocabulary 25 so Selector 27 only finds words starting with ‘ba’. For this embodiment, Vocabulary 25 has a ‘ba’ word set or a string of just enough word stems starting with ‘ba’ to fill a Handheld computer. The word set obtained includes the words starting with ‘ba’ of the set of FIG. 9a and the most frequent of those of FIG. 9b. The result, after the actions of Manager 15 and Selector 27, on Display 12 is the display of FIG. 9c.

Embodiments using FIG. 2b input ‘ba’ and other two letter SLSs as just described for FIG. 2a except that selection and strokes are executed with Mouse 13b and Buttons 13ba or 13bb instead of Stylus 13a. FIG. 2b embodiments with Desktop or Laptop displays allow Vocabulary 25 to have strings of the word stems of an abridged dictionary. FIG. 3b embodiments are the same except that selection of ‘B’ is all that is necessary to input ‘ba’. FIG. 3c embodiments input ‘ba’ with selection of “back”. Manager 15 puts ‘ba’, ‘bb’ and ‘bc’ in Word Buffer 21 for FIG. 2b ard just ‘ba’ for FIGS. 3b and 3c. Before calling Selector 27, Manager 15 copies the VFW and its ‘Associated Inputs’ (i.e “back”, “backs”, “backed”, “backing”, and “backer”). to Current Word Set 28. Selector 27 accesses the start of the ‘b’ string in Vocabulary 25 for ‘ba’ and copies the word stems starting with ‘ba’ to Current Word Set 28 along with inserting SLS ‘BA’ Marker and 3^{rd} letter Markers ‘B’, ‘C’, ‘D’,‘F’, etc. Selector 27, of course finds no words starting with ‘bb’ or ‘b’ for FIG. 2b.

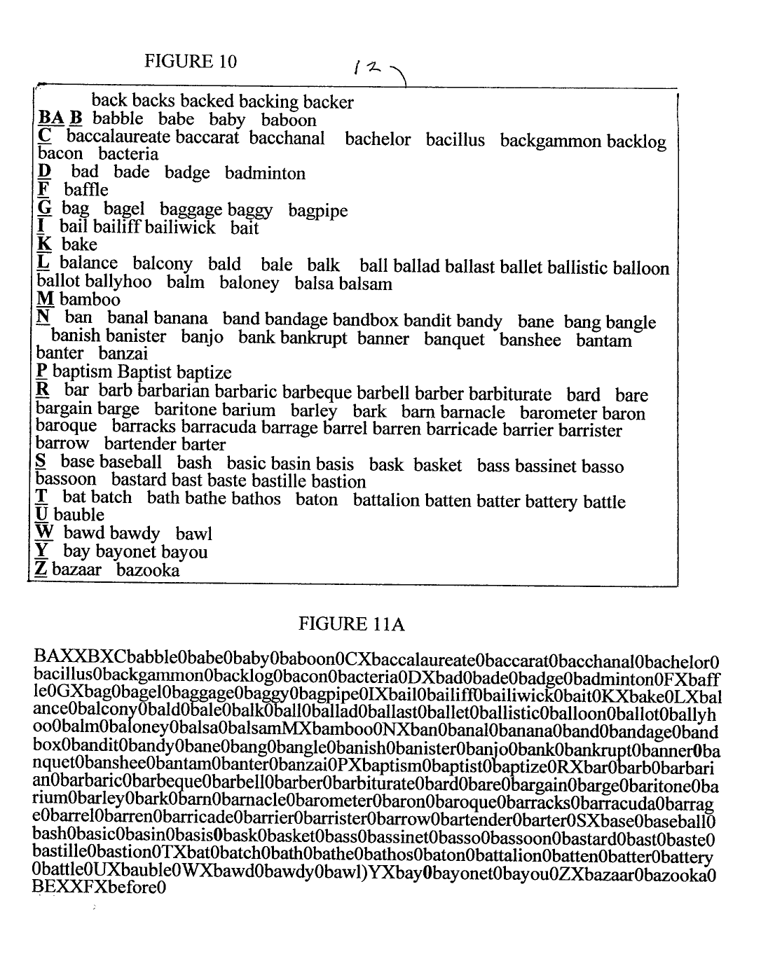

FIG. 10 shows the result for FIGS. 2b, 3b and 3c on Display 12 when Manager 15 copies Current Word Set 28 via Computer 11. The VFW and its ‘Associated Inputs’ of “back”, “backs”, “backed”, “backing”, and “backer” appear at the top of the set. Of the three word start presentations, only FIG. 3c shows the VFW “back”. It is useful to beginners on FIGS. 2b and 3b to have the VFW appear with the set obtained with the SLS. The option of obtaining the VFW and its inflected forms after the SLS input may be valuable. Strokes are not necessary to input “backs”, “backed”, “backing”, and “backer”. Just to select them with Mouse 13b and Buttons 13ba or 13bb. The next letter Markers start new lines in FIG. 9 to be easily searched. A discussion of the word stem strings as shown in FIGS. 10a and 10b will show how Selector 27 is able to determine the sizes of word sets and how best to display them on each Display 12. A larger word set or a smaller Display 12 on a Laptop computer might, for example, require the next letter Marker groups to be jammed closely together.

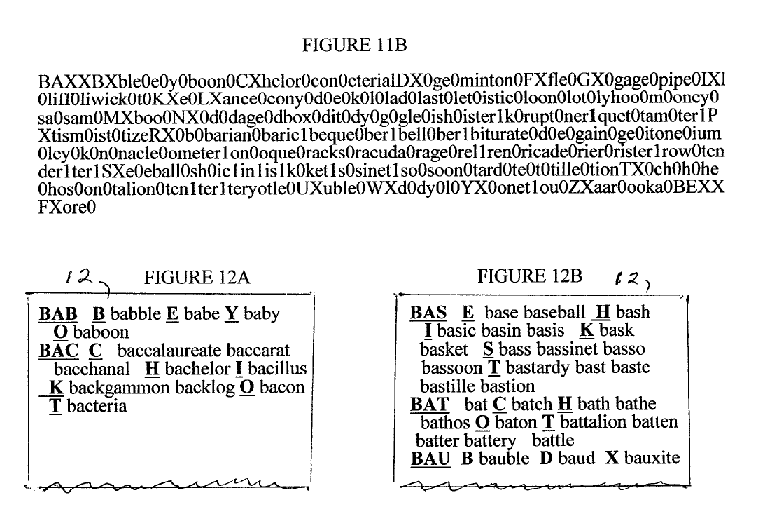

FIGS. 11a and 11b show strings all of the word stems of an abridged dictionary in slightly different forms. FIG. 11a has the word stems spelled out while FIG. 11b deletes two or more starting letters to save space and leaves it to Selector 27 to restore the letters when coping the word stems to Current Word Set 28. FIGS. 11a and 11b do not specify values for the jump bytes and the word stem codes. The ‘X’s indicate the jump byte places and ‘0’s represent the stem codes These simplifications do not impede an understanding of the strings and how Selector 27 functions. Jump values are simply the number of bytes to the target point. The codes may be one or more bytes, one with the high bit set, and others for a ‘Digit Letter’ code, if needed. (Examples of ‘Digit Letter’ codes are shown in FIG. 6aand have been previously discussed.).

The ‘ba’ word set starts with the SLS Marker ‘BA’ followed by two bytes ‘XX’.

The ‘ba’ word set starts with the SLS Marker ‘BA’ followed by two bytes ‘XX’ specifying a jump of up to 64K bytes to ‘BE’, the start of the next two letter word set for the letter ‘b’. The 3^{rd} letter marker, ‘B’, is followed by ‘X’ for a one byte jump to the next 3^{rd} letter marker. The word stems of the first 3^{rd} letter group starting with ‘bab’ follow, each ending in a ‘0’ representing their SIC. The next 3^{rd} letter marker ‘C’ is followed by an ‘X’ for the jump to the next 3^{rd} letter marker and the group of word stems missing their three starting letters of ‘bac’. The next 3^{rd} letter marker is ‘D’ and the first word stem of the group is ‘bad’, etc. Word Set Selector 27 takes the jumps to move quickly to the SLS of the current word and also used the values of the jumps and the size of Display 12 to determine the best arrangement for the word sets. As shown in FIG. 9, there was room to put the successive 3^{rd} letter groups on separate rows for FIGS. 3b and 3c models.

The FIG. 3a Handheld computer embodiment, like that of FIG. 2a, has a Display 12, that is not large enough for the FIG. 9 presentation. Both FIGS. 2a and 3a employ strokes with Stylus 13a after touch down to select an SLS input and add a ‘Letter Group’ or letter to obtain smaller word sets for Handheld computers. The difference is that FIG. 2a starts with single letters from the touch down locations and FIG. 3a with two letter SLSs. Users pick the ‘Letter Group’ with the 3^{rd} instead of the 2^{nd}, letter of the wanted word. In a first example, the stroke obtains the first ‘Letter Group’ of the letters ‘abc’ shown in FIG. 4b. ‘B’ of FIG. 3a obtains ‘ba’ where ‘B’ of FIG. 2a obtains ‘b’. FIG. 3a has various other 2^{nd} letters and some 3^{th} and 4^{th} letters as displayed items for other SLSs. FIG. 2a has to obtain the different 2^{nd} letters from strokes.

For FIG. 3a, Selector 27 extends ‘ba’ with the thee letters of the first ‘Letter Group’ to obtain SLSs of ‘baa’, ‘bab’ and ‘bac’. Selector 27 goes to the ‘BA’ SLS marker in Vocabulary 25, the start of the ‘b’ string shown in FIGS. 11a and 11b, and copies the ‘BA’ Marker to Current Word Set 28 and to an internal buffer. The first 3^{rd} letter Marker is ‘B’ so Selector 27 copies ‘B’ to Current Word Set 28 and advances to SLS ‘bab’. Selector 27 checks for new 3^{rd} letter Markers and for changing 4^{th} letters in words to proceed with the SLS ‘bab’ word set. Selector 27 inserts a 4^{th} letter Marker ahead of words with 4^{th} letters different than the last as it proceeds to copy the words starting with ‘bab’ to Current Word Set 27. The 3^{rd} letter Marker ‘C’ signals the end of the ‘bab’ word set. Selector 27 has SLS ‘bac’ still pending so it again copies the SLS Marker ‘BA’ to Current Word Set 28 and then the new 3^{rd} letter Marker ‘C’ before handling the ‘bac’ words as it did the ‘bab’ words, inserting 4^{th} letter Markers, etc. Manager 15 then transfers the contents of Current Word Set 28 via Computer 11 to Display 12 to produce the FIG. 12a presentation It will be noted that there is plenty of room on Display 12 of a Handheld computer for all of the words starting with the SLSs.

FIG. 12b shows the results of a second example. A stroke selects the seventh ‘Letter Group’ consisting of the letters ‘stu’ as shown in FIG. 4b. Selector 27 extends SLS ‘ba’ to SLSs ‘bas’, ‘bat’ and ‘bau’, copies ‘BA’ Marker to Current Word Set 28, and then jumps to successive 3^{rd} letter Markers until it finds ‘S’ for ‘bas’. Selector 27 then handles the ‘bas’, ‘bat’ and ‘bau’ word sets in turn as it did the ‘bab’ and ‘bac’ word sets. The result is the presentation of Display 12 shown in FIG. 12b. The wanted word for each example is in only one of the three letter SLS word sets presented. FIGS. 12a and 12b illustrate that the SLS and 3^{rd} letter Markers enables user to find the right word set with a glance. Next finding the right 4^{th} letter Marker is nearly as easy. Most 4^{th} letter groups have only a few words. Three relatively easy visual steps thus find the word wanted.

Most of the SLS inputs of FIGS. 2b, 3a, 3b and 3c consist of two starting letters which specify word sets of Main Vocabulary 25 displayable on Desktop Computers. (Where Main Vocabulary 25 holds the word stems of an abridged dictionary, such as “The New American Webster Handy Dictionary” in strings.) FIG. 2b obtains its consonant vowel SLSs with eight straight strokes from consonant capitalized letters selecting ‘Letter Groups’. The ‘Letter Groups’ are nearly as effective as single letters as the consonants form few words with other than the single vowel and vowellike letters of each ‘Letter Group’. Vowel starts make more use of the SLSs of VFWs. (FIG. 2a similarly obtains two letter SLSs but the word sets do not fit on Handheld computers.) FIGS. 3a and 3b obtain two letter SLSs directly from the many displayed items consisting of 2^{nd} letters. Some displayed items obtain an alphabetic range of 2^{nd} letters for composite word sets which still fit on Desktops and Laptops. FIG. 3a adds ‘Letter Groups’ to the two letter SLS selections with strokes to produce three letter SLSs to obtain word sets o fit on Handheld computers. The fill set of VFWs of FIG. 3c yields a full set of two letter SLSs.

Some two letter SLS word sets, however, are too large to fit on Desktop computers. FIGS. 2b, 3a, 3b and 3c include means to produce three and four letter SLSs to break the large sets into sets displayable on Desktops. FIG. 2b has VFWs with the necessary three and four letter SLSs. FIGS. 3a and 3b have displayed items for 3^{rd} and 4^{th} letter inputs. FIG. 3c, like FIG. 2b, has VFWs to produce three and four letter SLSs. For these embodiments, Manager 15 and Selector 27 give ‘co’, ‘in’ and ‘re’ special handling to obtain word sets from ‘co’ to ‘com’, ‘in’ to ‘int’, and ‘re’ to ‘rem’ respectively. FIG. 2b uses the ‘Sections’ of FIGS. 5a, 5b and 5c to obtain ‘com’, ‘comp’, ‘con’, ‘cont’ and ‘conv’ from “come” and its following ‘Space’. FIG. 2b ‘Sections’ further obtain ‘int’ and ‘inv’ from “into”; and ‘rem’ from “red”. In FIGS. 3b and 3c, square brackets, ‘[ ]’, mark off the 3^{rd} and 4^{th} letter inputs for ‘com’, ‘omp’, ‘con’, ‘cont’, ‘conv’, ‘int’, ‘int’, ‘inv’ and ‘rem’. FIG. 3a omits the square brackets, ‘[ ]’, to save display space, and distinguishes 3^{rd} and 4^{th} letters by spacing. The ‘com’ obtains ‘com’ to ‘comp’; ‘comp’ obtains ‘comp’ to ‘con’; ‘con’ obtains ‘con’ to ‘cont’; ‘cont’ obtains ‘cont’ to ‘conv’; and ‘conv’ obtains ‘conv’ to ‘conz’ The ‘int’ obtains ‘int’ to ‘inv’, and ‘invv’ obtains ‘inv’ to ‘inz’. The ‘rem obtains ‘rem’ to ‘rez’.

Auxiliary Vocabulary 26 will preferably hold its sets of word stems in strings such as those of FIGS. 10a or 10b. Vocabulary 26 may include modules of Proper Nouns, of frequently used abbreviations, and professional or technical terms. Manager 15 directs Word Set Selector 27 to access the ‘Proper Nouns’ and ‘Technical Terms’ modules of Auxiliary Vocabulary 26 in response to CCW strokes D5 and D6 respectively as shown in FIG. 4b. These strokes start from a capitalized starting letter which Selector 27 uses to access a word set in the respective module. This route will be employed when users know the word wanted is in Auxiliary Vocabulary 26, as will generally be the case for Proper Nouns and technical terms. Another route is from an input made from a two or more letter SLS word set in Main Vocabulary 25 after a wanted word is not found and it is realized that it might be in Auxiliary Vocabulary 26. The same CCW strokes D5 and D6 executed from the word set cause Selector 27 to switch access to Vocabulary 26 using the SLS already inputted.

Unabridged Vocabulary 30 holds the remaining words of an unabridged dictionary less those of Main Vocabulary 25 and Auxiliary Vocabulary 26. Users switch to Vocabulary 30 after searching for wanted words in Vocabulary 25 by executing a stroke to add another letter to the SLS already inputted. Manager 15 responds to additional letter inputs by directing Word Set Selector 27 to switch access of Selector 27 to Unabridged Vocabulary 30. The word stems of Vocabulary 30, like those of Vocabularies 25 and 26 are in strings such as those of FIGS. 10a or 10b. After switching to Vocabulary 30, Selector 27 locates the start of the string for the starting letter of the SLS and takes successive 2^{nd} letter jumps to first a match on the string with the 2^{nd} letters of the input SLS. Selector 27 continues with successive 3^{rd} letter jumps to match the 3^{rd} letter, etc. Selector 27 copies SLSs and Markers along with words matching the input SLS to Current Word Set 28 for further action as for word sets from Vocabularies 25 and 26.

FIG. 13 shows the blocks of FIG. 1 which are modified for a Japanese language model or hold different data. Text Input Manager 15a performs of the functions of Manager 15 along with some new ones for the Japanese model. Queue 17a and Stroke Analyzer 18a are substantially the same as Queue 17 and Analyzer 18 but with some changes. Word Start Arrays 19a, Inflections Sets 22a and Current Word Set 28a are also substantially the same as their corresponding blocks of FIG. 1 but also with different content and some changes. Input Buffer 21a has its name changed to indicate that its functions are somewhat different. Word Set Selector 27a has some old and some new functions. Phonetic Word Vocabulary 31 and Kanji Word Vocabulary 32 substitute for old Main Vocabulary 25.

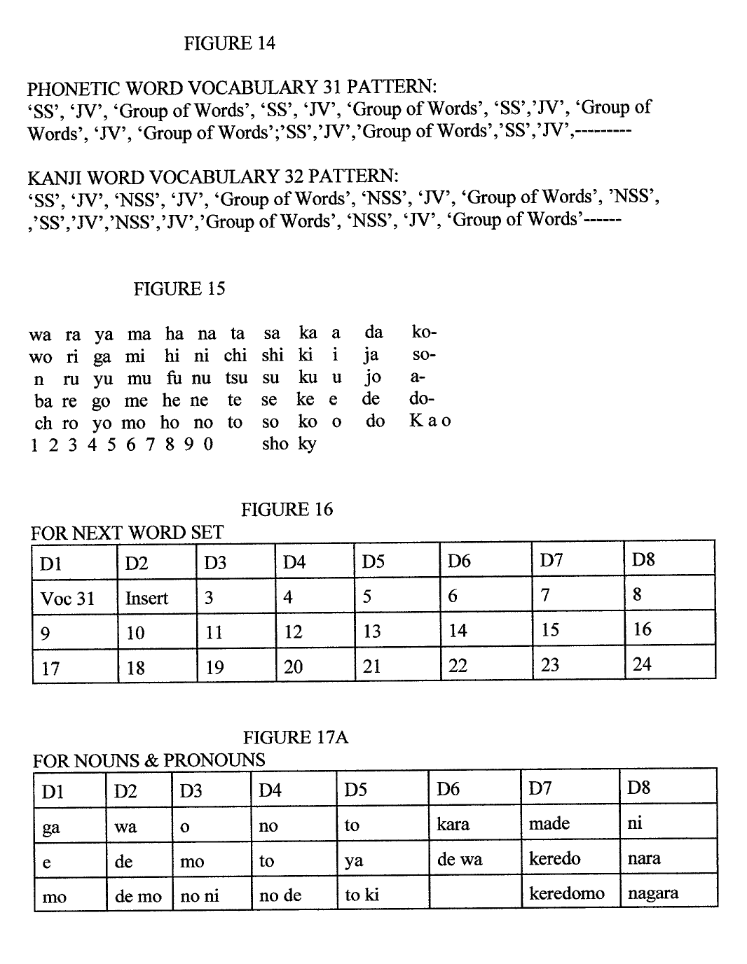

Phonetic Word Vocabulary 31 holds the Japanese words not including Kanji, or Ideographic, characters but written phonetically with Japanese kana characters. Kanji Word Vocabulary 32 holds the Japanese words with one or more Kanji characters. All word have a part of speech code identifying them as a noun or pronoun, a verb, or an adjective or adverb. Syllable Separators, or ‘SSs’, mark the groups of words starting with each different syllable. In the Kanji Word Vocabulary 32, Number of Strokes Separators, or ‘NSSs’, further divide the word groups into smaller groups according to the number of strokes forming their first Kanji character. Each ‘Separators’ is accompanied by a Jump value, or ‘JV’, to the next ‘Separator’ as shown in FIG. 14.

The word start presentation of FIG. 15 shows the Japanese starting syllables in westernized spelling for the convenience of Applicant's word processor. It will be recognized by those skilled in the art that a presentation in Japanese text would represent the same information and be obvious for Japanese users. The syllables of FIG. 15 are the ‘SSs’ of both Vocabularies 31 and 32. Where syllables are not included, such as those between ‘ga’ and ‘go’ for example, those between follow the first shown. (i.e. ‘g’ and ‘gi’ follow ‘ga’ and ‘gu’ and ‘gy’ follow ‘go’.) The set of digits completes the displayed items of FIG. 15. Each displayed syllable has a VFW assigned which is generally the most frequent word starting with the respective syllable. The syllables, or rather their kana equivalents, can also be directly inserted in the inputted text.

With Mouse 13b as Pointer 13, operation of Button 13bb for selection of a syllable of FIG. 15 enables the stroke assignments of FIG. 16. Manager 15a puts the syllable in Input Buffer 21 and awaits the next action. If the next action is release of Button 13bb, Manager 15a inputs the kana equivalent of the syllable in Buffer 21 to the text document in Word Processor 16. The first stroke of the first set in direction D1 has Manager 15a directing Word Set Selector 27a to access Vocabulary 31 for matches between the ‘SSs’ and the selected syllable in Buffer 21. Manager 15a responds to the following strokes of the three sets of FIG. 15 by putting the respective number, 2 through 24, in a different location in Buffer 21. Manger 15a next directs Selector 27a to access Vocabulary 32 for matches between the ‘SSs’ and the syllable in Buffer 21 and the ‘NSS’ and the number in Buffer 21. As in other models, Selector 27a copies the words with the matching attributes to Current Word Set 28a. In the case of Vocabulary 31, these are the words from the matching ‘SS’ to the next ‘SS’. In the case of Vocabulary 32, these are the words following the matching ‘NSS’ after the matching ‘SS’ to the next ‘NSS’. The number is the number of strokes forming the first Kanji character of these words. Manager 15a transfers the contents of Current Word Set 28a to Display 12 via Computer 11.

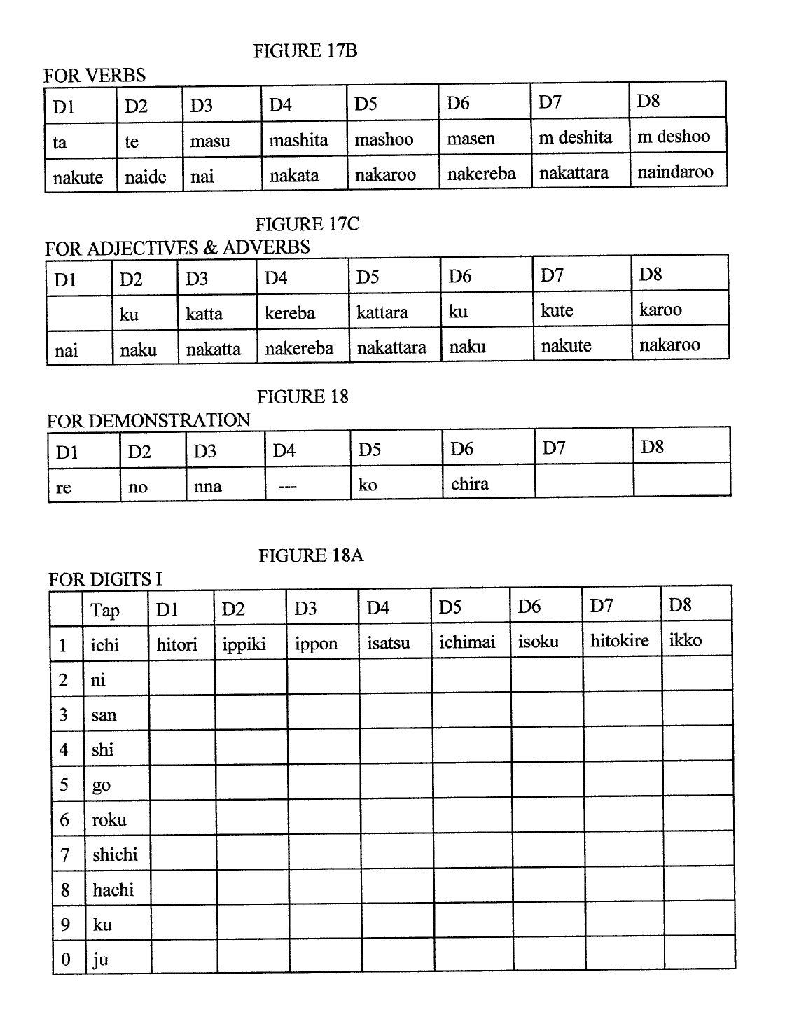

On word starts, operation of Button 13ba has Manager 15a inputting the VFW assigned to the displayed item and its code to Input Buffer 21. After word starts, selection of a word from aa accessed and displayed word set has Manger 15 similarly putting the word and its code in Buffer 21. If the VFW or word is a noun, or a pronoun, the code enables the stroke assignments of FIG. 17a. If the VHF or word is a verb, the code enables the assignments of FIG. 17b. If the VFW or word is an adjective or adverb, the code enables those of FIG. 17c. FIG. 17a has the post positions of Japanese text which follow nouns and pronouns in sentences. FIG. 17b has the verb inflections and FIG. 17c the adjective inflections. The words from Vocabularies 31 and 32 have the same codes to select the FIGS. 17a, 17b, and 17c assignments of strokes as do the VFWs. Manager 15a responds to a stroke by inserting the assignment of the set enabled by the VFW or word code to the VFW or word in Buffer 21 Manager 15a transfers the contents in Buffer 21 to the text document in Word Processor 16 on release of Button 13ba. Alternatively, Manager 15a could put the selected VFWs or words directly in the text document and insert stroke assignments in the text document.

Stylus 13a as Pointer 13, without the advantages of Buttons 13ba and 13bb, has to otherwise distinguish inputs for accessing Vocabularies 31 and 32 from inputs for VFWs. Manager 15a inserts the kana equivalent of the selected syllable directly into the text document in Word Processor 16 as a post position in response to operation of both Buttons 13ba and 13bb or to a tap with Stylus 13a. The sets of Stylus 13a strokes for FIG. 16 assignments 16 must be different than the sets of strokes for the assignments of FIGS. 17a, 17b, and 17c. The present mode uses a ‘Stop’ before lifting to distinguish strokes for accessing and lifting without a ‘Stop’ for strokes to add post positions or inflections to words. Other models might use curves or hooks for one set of sets. The FIG. 17a assignments enable inputting of pronouns and nouns and following post positions with single actions. FIG. 17b enables single action input of verbs and their inflectional endings of strings of kana characters. FIG. 17c similarly enables single action input of adjectives and adverbs with their inflectional endings of strings of kana characters.

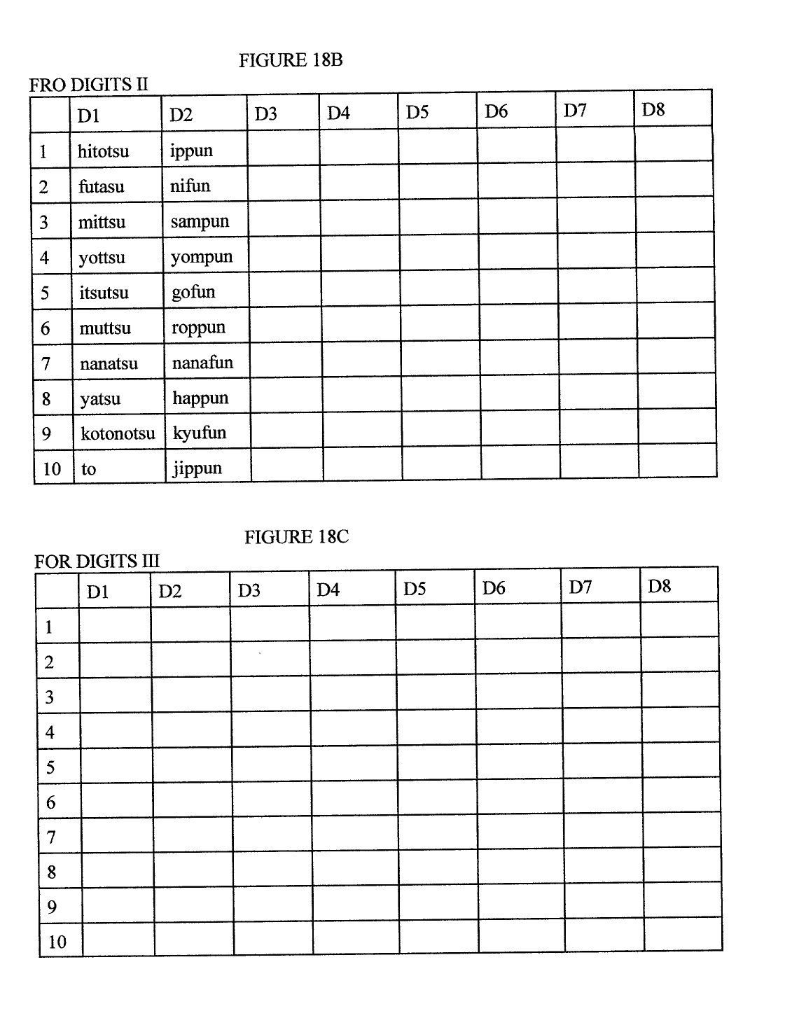

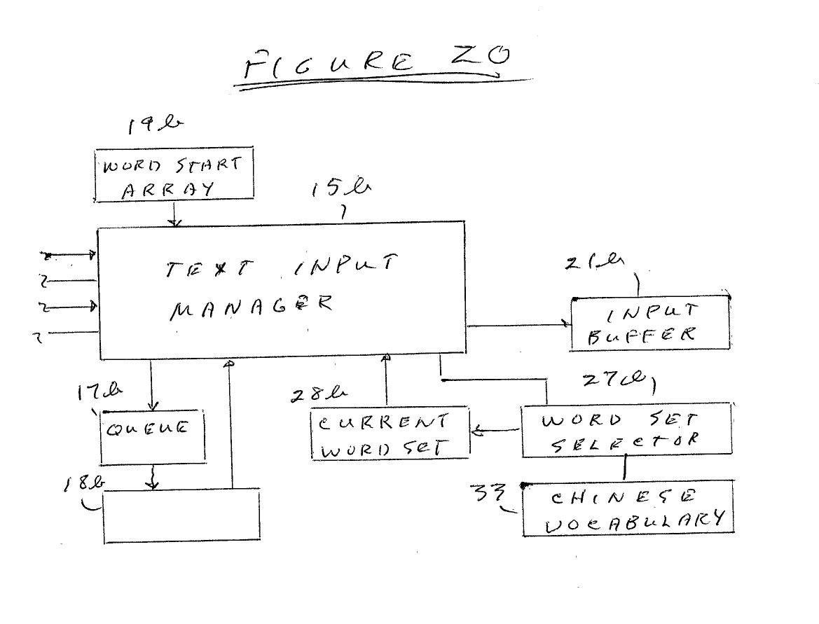

The FIG. 15 presentation has displayed items other than that of the syllables with VFW companions previously discussed. The ‘so-’, ‘ko-’, ‘a-’, and ‘do-’ in the last column of the FIG. 15 presentation are the roots for demonstrative and interrogative pronoun as distinguished from the ‘so’, ‘ko’ and ‘a’ displayed items for syllables and VFWs in other locations. The first row of FIG. 18 has a set of endings for appending to these roots to obtain to demonstrative an interrogative pronouns. The last four rows show the words which Manger 15a inputs in response to Pointer 13 selection of the respective roots and execution of the respective strokes. It will be recalled that the Digits of the previous models had the several inputs of FIG. 7c for strokes from each digit. The Digits on the last row of the FIG. 15 presentation are the key to an even larger number of inputs to handle the many Classifiers used with numbers in Japanese. The large number of different strokes required Japanese language parameters are further able to handle as many Classifiers as wanted or necessary. FIGS. 19a and 19b show a few by way of example.

FIG. 15 has room for more displayed items for VFWs not obtainable as the most frequent word starting with each of the set of syllables. In English, for example, many very frequent words start with ‘th’ and ‘wh’ and had to be handled apart from the most frequent from ‘th’ and ‘wh’. Applicant's knowledge of Japanese is too limited to specify what these should be in the present case. In view of the system shown and explained, those skilled in the art can add displayed items and assignments for as many additional VFWs as necessary. Laptops and Desktops have plenty of room for the FIG. 15 presentation and for display of the word sets obtained from Vocabularies 31 and 32. Arrangements such as those of previously discussed FIG. 3a can present the FIG. 15 data in a much smaller space if necessary for Handheld computers. The starting letter and 2^{nd} letter combinations are easy to understand but would be westernized. Smaller word sets from Vocabularies 31 and 32 require input of additional attributes, such as the first letters, or sounds, of second syllables of words. These could be inputted by strokes cascaded with the strokes inputting the number of strokes. Not all of the letters of western alphabets would be necessary.

FIG. 20 shows variations in the block diagrams of FIGS. 1 and 13 for a Chinese language model. Chinese Vocabulary 33 is modeled after Mathews' Chinese English Dictionary which has Chinese words listed in alphabetic order for pronunciation and by numbers from a Radical Index. Except for the omission of Inflection Sets 22a, the rest of the blocks are the same as those of FIG. 13 for the Japanese model. Vocabulary 33 includes the Radical Index of Mathews' Dictionary for use by Word Set Selector 27b in accessing word sets in Vocabulary 33. The Chinese use Ideographic Radicals as keys for accessing words in the dictionary. The Radicals are Ideographic characters that also key parts of other Ideographic characters. Mathews' Chinese English Dictionary shows 214 Radicals identified by numbers 1-214. The first step in locating a wanted word is identifying the Radical of its first Ideographic character and noting its number. The next step uses the Radical number to index into the Radical Index.

The Radical Index lists the Ideographic characters with each Radical in groups ordered by the number of strokes in addition to the Radical to complete the Ideographic characters. Each different number of strokes breaks to Radical group into section. In the case of Mathews, each entry has an index number to access the dictionary word list. Other dictionaries use the starting syllables of the word entries, instead of index numbers. The Mathews' numbers index into the dictionary word list to the start of words with the Radical that may include the word wanted. To summarize, the Radial of the first Ideographic character of a word leads to a list of words in the Radical Index each starting with an Ideographic character having the Radical. The word list has sections for each number of strokes to complete their Ideographic characters with the Radical. The index numbers locate the portions of the dictionary word list which may have the word wanted.

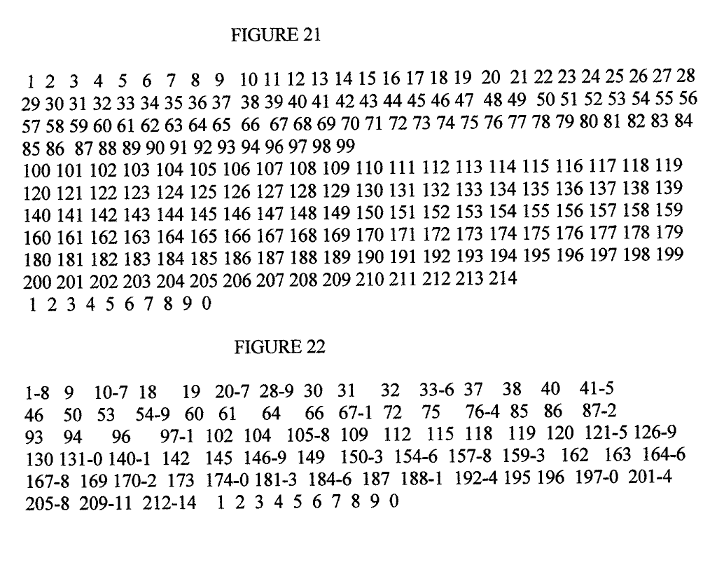

The word start display of FIG. 21 shows the numbers 1 through 214 indicating their respective Radical. Those skilled in the art will recognize that the actual Radicals could be substituted for their respective numbers. In that case, the numbers would be assigned to the displayed items so selection of a Radical by Pointer 13 would obtain its number to index into the Radical Index. As with the Japanese syllables, execution of a stroke inputs a number for Word Set Selector 27b to use along with the Radical number to index into the Radical Index. Selector 27b then obtains the numbers or starting syllables of words listed in the Radial Index requiring the appropriate number of strokes. Each number indexes a location in Chinese Vocabulary 33. Selector 27b copies the words from each indexed location to Current Word Set 28b. As in other models, the contents of Current Word Set 28b are displayed for selection. With an appropriate amount of abridging for Vocabulary 33, the word sets thus obtained will be displayable on Laptop and Desktop computers.

Each of the Radicals, or numbers identifying Radicals, also has a VFW assignment. The VFW is the most frequent word with the respective Radical. As in other models, Buttons 13ba and 13bb determine whether Mouse 13b selection of the displayed item of a Radical inputs the VFW or the number to access Vocabulary 33. Stylus 13a obtains VFWs with taps and adds strokes to input not only the Radical number but the number of Ideographic strokes to access Vocabulary 33. FIG. 22 shows an alternative word start presentation in which some of the displayed items represent ranges of Radical numbers just as some inputs of FIG. 3a represented alphabetic ranges of 2^{nd} letters.

As in the other models, Managers 15a and 15b obtain the data for the word start display from Word Start Arrays 19a and 19b for the respective presentations. Managers 15a and 15b also uses data from Arrays 19a and 19b to determine the displayed items ‘hit’ by selections with a Stylus 13a or a Mouse 13b. Queues 17a and 17b holds the successive positions of Pointer 13, as did Queue 17, and Stroke Analyzers 18a and 18b use the successive positions to identify the strokes as did Analyzer 18. Analyzer 18a has to cover a larger number of different stroke identities to cover the assignments of FIG. 16 and FIGS. 17a, 17b, and 17c.

As in other models, Buttons 13ba and 13bb obtain the VFWs or the word attributes to access word sets respectively for input. Manager 15a has Word Set Selector 27a access Phonetic Word Vocabulary 31 with syllable inputs to obtain word sets. When execution of strokes adds the number of strokes for Kanji characters to the input, Manager 15a directs Selector 27a to instead access Kanji Word Vocabulary 31 instead. Selector 15a checks the number of stroke codes of the words with the syllable starts against the number of stroke inputs to determine eligibility for the word set.

In the claims:

1. The method for inputting text to a computer type apparatus having a data processing means, a text handling system, a memory, a display, and a pointing means comprising the steps of:
a) displaying a plurality of items on said display for word starts;
b) assigning a very frequent word, or VFW, to each said items;
c) selecting one of said items with said pointing means; and
d) inputting the VFW assigned to the selected one of said items to said text handling system.

2. The method according to claim 1 wherein said memory holds a set of inflection suffixes and including the steps of:
e) designating each of inflection suffixes to a direction and a pattern;
f) moving said pointing means in a chosen direction and pattern; and
g) applying the inflection suffix designated to the chosen direction and pattern to the VFW of step d).

3. The method according to claim 2 wherein the number of directions is eight and there are more than one pattern.

4. The method according to claim 1 wherein the one of said VFWs have a set of related words and including the steps of:
e) designating each of said related words to a direction and a pattern;
f) moving said pointing means in a chosen direction and pattern; and
g) substituting the one of said related words designated by the chosen direction and pattern for the VFW in step d).

5. The method according to claim 1 wherein the one of said VFWs assigned to the selected item has a set of 2^{nd} words assigned and including the steps of:
e) designating each of said 2^{nd} words to a direction and a pattern;
f) moving said pointing means in a chosen direction and pattern; and
g) inserting the one of said 2^{nd} words designated by said chosen direction and pattern to accompany the VFW in step g).

6. The method according to claim 1 wherein said memory holds a set of punctuation and other word endings and including the steps of:
e) designating each of said punctuation and other word endings to a direction and a pattern;
f) moving said pointing means in a chosen direction and pattern; and
g) applying the ending designated to said chosen direction and pattern to the VFW of step d).

7. The method according to claim 1 wherein one of said VFWs is the word “a” and said memory holds a special set of characters and letter strings starting with vowel sounds and including the steps of:
e) designating the location to which the word “a” is inputted;
f) comparing the starting to the next word inputted with said special set; and
g) inserting the letter ‘n’ to append to the inputted word “a” if step f) finds a match.

8. The method according to claim 1 wherein said memory holds each digit with a set of members comprising related words, related number values, and related characters and wherein the displayed items of step a) include said digits and wherein said method includes the steps of:
e) picking one of said displayed items representing a digit with said pointing means;
e) designating each of said digit related members to a direction and a pattern;
f) moving said pointing means in a chosen direction and pattern; and
g) transferring the member designated to the chosen direction and pattern to said text handling system.

9. The method according to claim 1 wherein said memory holds a plurality of sets of word stems, and including the steps of:
e) also assigning a starting letter string, or SLS, to each said items;
f) picking the VFW or SLS assigned to the selected item with said pointing means;
g) accessing a set of said word stems associated with each picked SLS;
h) presenting the accessed word stem set on said display; and
i) obtaining one of the word stems presented with said point means; and
j) substituting the word stem obtained for the VFW in step d).

10. The method according to claim 9 wherein said pointing means includes two buttons and wherein step f) is replaced by the step of:
k) operating one of said buttons to pick the assigned VFW or SLS.

11. The method according to claim 9 wherein said memory holds strings of word stems and a set of letters each assigned to a direction and a pattern and wherein steps f) and g) are replaced by the steps of:
k) moving said pointing means in the direction and pattern to which one of said of letters is assigned.
l) extending the SLS with said letter to a longer SLS; and
m) accessing a set of words for said longer SLS.

12. The method according to claim 9 wherein said memory holds strings of word stems and groups of letters each assigned to a direction and a pattern and wherein steps k), g) and m) are replaced by the steps of:
k) moving said pointing means in the direction and pattern to which one of said of group of letters is assigned.
l) extending the SLS with each of the letters of said group to longer SLSs; and
m) accessing the word stems with starting letters matching said longer SLSs.

13. The method for inputting text to a computer type apparatus having a data processing means, a text handling system, a memory holding sets of words assigned to starting letters, a display, and a pointing means comprising the steps of:
a) presenting a set of starting letters, or SLs, and a set of very frequent words, or VFWs, on said display as displayed items for word starts;
b) selecting one of said VFWs or one of said SLs with said pointing means;
c) inputting selected VFWs to said text handling system;
d) accessing said memory for the set of words assigned to selected SLs;
f) displaying the sets of words accessed on said display; and
g) obtaining one of the words from said displayed set with said pointing means;
h) transferring the obtained word to said text handling system.

14. The method according to claim 13 wherein said memory also holds a set of inflection suffixes and including the steps of:
i) assigning each of said inflection suffixes to a direction and a pattern;
j) moving said pointing means in a chosen direction and pattern;
k) applying the inflection suffix assigned to the chosen direction and pattern to the selected VFW of step b); and
l) substituting the result of step k) for the VFW in step c0.

15. The method according to claim 13 wherein said memory holds second sets of word sets and including the steps of:
i) assigning each of a set of different inputs of letters and access of said second sets of word sets to a direction and a pattern;
j) moving said pointing means in a chosen direction and pattern;
k) setting up the input assigned to the direction and pattern chosen; and
l) inputting the input set up to said test handling system.

16. The method for inputting text to a computer type apparatus having a data processing means, a text handling system, a memory, a display, and a pointing means comprising the steps of:
a) displaying a plurality of items on said display for word start inputs;
b) assigning a text unit with multiple inputs to each of said displayed items;
c) designating each of said multiple inputs to a direction and a pattern;
c) selecting one of said displayed items with said pointing means;
d) moving said pointing means in a chosen direction and pattern;
e) inputting the one of said multiple inputs designated to the chosen direction and pattern to said text handling system.

17. The method according to claim 16 wherein there eight directions and more than one pattern.

18. The method according to claim 17 wherein one of said patterns is a ‘Hop’ or movement above the surface.

19. The method according to claim 17 wherein said patterns are straight lines and one of said patterns is distinguished by a starting delay.

20. The method according to claim 17 wherein said patterns are straight lines and one of said patterns is distinguished by an ending stop.

21. The method according to claim 1 wherein the items displayed represent the starting syllables of Japanese words and wherein each VFWs has a code representing the part of speech of the VFW.

22. The method according to claim 21 wherein said memory holds a set of Japanese language post positions and including the steps of:
e) designating each of said post positions to a direction and a pattern;
f) moving said pointing means in a chosen direction and pattern; and
g) inserting the post position designated to said chosen direction and pattern to follow the VFW of step d).

23. The method according to claim 1 wherein the items displayed represent the Radicals of Ideographic characters.
